(19) United States
(12) Patent Application Publication
(10) Pub. No.: US 2020/0346934 A1
(43) Pub. Date: Nov. 5, 2020

(54) LATTICE-ENGINEERED CARBONS AND THEIR CHEMICAL FUNCTIONALIZATION

(71) Applicant: GRAPHENE TECHNOLOGIES, INC., Novato, CA (US)

(72) Inventors: Abhay V. THOMAS, Novato, CA (US); Matthew BISHOP, Novato, CA (US)

(21) Appl. No.: 16/758,580

(22) PCT Filed: Oct. 23, 2018
(86) PCT No.: PCT/US2018/057082

§ 371 Date: Apr. 23, 2020

Related U.S. Application Data
(60) Provisional application No. 62/576,433, filed on Oct. 24, 2017.

(51) Int. Cl. C01B 32/194; C09C 1/44; C07F 7/18

(52) U.S. Cl. CPC C01B 32/194; C09C 1/44; C07F 7/1804; C01P 2002/82; C01P 2002/85; C01P 2004/03; C01P 2004/04; C01P 2002/88; C01P 2002/78

(57) ABSTRACT

A chemically functionalized carbon lattice formed by a process comprising heating a carbon lattice nucleus in a reactor to a temperature between room temperature and 1500 C. The process also may comprise exposing the carbon lattice nucleus to carbonaceous gas to adsorb carbon atoms in the carbonaceous gas onto edges of the carbon lattice nucleus, covalently bond the adsorbed carbon atoms to one another in polyatomic rings, a portion of the polyatomic rings comprising non-hexagonal rings, covalently bond the polyatomic rings to one another in one or more new lattice regions extending off the carbon lattice nucleus thereby forming an engineered lattice incorporating the non-hexagonal rings, exposing a portion of the engineered lattice to one or more chemicals to bond at least one of a functional group and molecule to the engineered lattice.

### CROSS-REFERENCE TO RELATED APPLICATIONS

This application claims priority to U.S. Provisional Patent Application Ser. No. 62/576,433 filed Oct. 24, 2017, which is hereby incorporated by reference in its entirety for all purposes. The application is also related to PCT/US17/17537 filed Feb. 10, 2017, which is hereby incorporated by reference in its entirety for all purposes.

### FIELD OF DISCLOSURE

The following disclosure relates to processes and materials used to synthesize chemically functionalized carbon-based materials. The synthesis may be accomplished by synthesizing a lattice-engineered carbon via autocatalyzed lattice growth and may include chemical functionalization of the carbon-based materials. More particularly, this disclosure relates to the synthesis of carbon lattices and multilayer lattice assemblies with controlled concentrations of non-hexagonal rings and to the covalent addition of functional groups to the basal planes of these lattices and assemblies.

### BACKGROUND

A common method of synthesizing “low-dimensional carbons”¹ involves the chemical vapor deposition (CVD) of polycyclic carbon macromolecules. A polycyclic carbon macromolecule, also referred to herein as a “carbon lattice” or “lattice,” is an atomic monolayer sheet (i.e., a sheet having a thickness of a single atom) of carbon atoms bonded to each other via sp²-hybridized bonds in polyatomic ring structures. FIG. 1 illustrates a graphene lattice, comprising carbon atoms bonded to one another in hexagonal ring structures. During CVD, carbonaceous gas molecules contact a catalyst material, e.g., a transition metal foil, that catalyzes the decomposition of the gas molecules and results in the deposition of a carbon lattice onto the catalyst. After synthesizing the lattice, or a multilayer assembly of lattices, the lattice's properties may be modified by chemically functionalizing it. This process of adding functional groups often requires harsh, poorly-controlled oxidation reactions such as Hummer's Method. Defined herein as carbon-based structures with at least one structural feature 100 nm in size or smaller.

There is an unmet need in the art for milder, more controllable processes for producing chemically functionalized carbons. There is also an unmet need for carbons with side-specific, site-specific, stratum-specific, and group-specific functionalities. In general, more sophisticated functional architectures at the lattice level and particle level can be used to devise carbons with optimal properties for specific applications.

Utilization of commodity carbons as lattice nuclei (e.g. carbon black or graphite) would enable useful modifications of these carbons' chemical functionality. It has been shown that carbon blacks and activated carbons can be used as inexpensive catalysts to produce hydrogen from hydrocarbon gases, which results in potentially valuable carbon byproducts. However, the tiling and structure of the new lattice regions synthesized with these nuclei have not been closely examined, nor has their chemical functionalization been explored. Therefore, there is also an unmet need in the art for the chemical functionalization of carbon-catalyzed lattices and lattice assemblies produced via hydrocarbon reforming.

### SUMMARY

This disclosure describes, among other things, novel processes and materials related to the autocatalyzed growth of engineered carbon lattices and lattice assemblies. It also describes use of lattice-engineered carbon as feedstocks for creating chemically functionalized nanostructured carbons, in particular via oxidation reactions.

Also described herein are novel processes and materials related to the autocatalyzed growth of engineered carbon lattices and lattice assemblies with lattice characteristics that allow for selective chemical functionalization. This includes use of these materials as feedstocks for side-selective, site-selective, region-selective, stratum-selective, and group-selective functionalizations. In particular, this disclosure describes the utilization of engineered carbon lattices and lattice assemblies with reactive surfaces to obtain basal plane oxidation.

The methods and materials described herein offer several advantages over the prior art. For example, lattice-engineered carbons described herein may be more chemically reactive than graphene or graphitic carbons. As feedstocks for chemical functionalization processes, lattice-engineered carbons may therefore be more easily and controllably functionalized. This may obviate the need for more aggressive functionalization processes utilized on graphitic feedstocks, such as Hummer's Method, and enable the use of milder, safer, and more environmentally-friendly functionalization processes.

Under certain CVD conditions, a carbon lattice may self-catalyze (“autocatalyze”) its own growth in the absence of a catalyst. Modeling of this phenomenon via Density Functional Theory predicts, for example, that hexagonal lattices may be grown without a non-carbon catalyst via dissociative adsorption of methane at the lattice edges. The carbon adatoms then bond to one another and assemble into new ring structures that are incorporated into the lattice. Concurrently, the lattice edge is regenerated and can adsorb new carbon adatoms. In this autocatalyzed mode of growth, a carbon lattice performs the role of the catalyst.

Due to the catalytic role of the lattice, autocatalyzed growth processes require a “carbon lattice nucleus,” “nucleus,” or “seed.” The nucleus, as defined herein and illustrated in FIG. 2, is the initial structural state of the lattice over some arbitrary time interval during which autocatalyzed lattice growth occurs. As such, the nucleus is not defined by its size, geometry, or ring structure, but merely by its designation as the structural starting point of some augmented lattice structure grown from the nucleus over the interval of autocatalyzed growth. At the endpoint of the interval, new regions of the lattice, i.e. regions that did not exist in its nuclear state, are referred to as “new growth regions” or “new regions.” These regions are also illustrated in FIG. 2.

In an autocatalyzed CVD process, a preexisting lattice nucleus may be introduced into the CVD reactor and then grown via autocatalysis. Alternatively, it may be both nucleated and grown in situ. Nucleation may be induced by a non-carbon catalyst (e.g. a metal, metal oxide, metal carbonate, metal halide). Alternatively, if nucleation occurs without a non-carbon catalyst (e.g. a nucleus is formed on the surface of another carbon lattice, or formed via gas-phase pyrolysis of a hydrocarbon), it is referred to herein as “autonucleation.”

Autocatalyzed growth can occur in several contexts. One context is in isolation—i.e. no region (“region” is defined herein as any contiguous subset of the carbon atoms comprising a two-dimensional carbon lattice, as illustrated in FIG. 3) of the growing lattice is in contact with another solid-state molecule or particle. Another context is on a support—i.e. one or more regions of the lattice are in contact with a larger solid-state molecule or particle. Another context, similar to supported growth, is when one lattice is in overlapping contact with itself or another carbon lattice. Overlapping contact comprises contact between two lattice sides. “Sides,” as illustrated in FIG. 3, are defined herein as the two lattice faces associated with any given region of a carbon lattice. There will always be two sides in any lattice geometry excluding certain topological anomalies such as a Möbius strip, in which case the two “sides” may be simply thought of as the two localized faces created by a local region of the lattice. The lattice's sides, being two-dimensional features, are distinct from the lattice's “edges,” which are the one-dimensional terminus or termini of a lattice.

Overlapping contact between two lattice sides may occur during CVD growth; for instance, when lattices grown from multiple, nearby nuclei on a common supporting surface encounter one another, they may subduct or be subducted by one another, forming an overlap. Alternatively, a lattice may overlap itself (e.g. in a folded configuration, which is created when one side comes into contact with itself, or in a scrolled configuration, which occurs when one side comes into contact with the other side, respectively). When a lattice overlaps itself or another lattice, the overlapping architecture that is referred to herein as a “multilayer feature.” Any carbon structure comprising one or more multilayer features is herein referred to as a “multilayer structure” (“MS”). As illustrated in FIG. 4, multilayer structures may comprise numerous geometries.

In a multilayer structure, each overlapping lattice region is referred to as a “layer.” While it is possible for a single lattice to comprise two or more layers (e.g. a folded nanoplatelet or scrolled nanotube), the most common type of multilayer structures are comprised of multiple lattices (e.g. graphitic stacks of lattices or multiwall nanotubes). In carbons grown via template-directed CVD, the walls grown around the template are typically multilayer structures. The walls may include lattices overlapping other lattices, as well as lattices wrapped around themselves in three dimensions.

Lattices may comprise different ring structures and different molecular patterns (herein referred to as “tilings”). Crystalline arrangements of sp²-bonded carbon atoms organized into repeating, hexagonal rings are known as “graphene” and possess a regular honeycomb tiling. Some graphene lattices may incorporate a small concentration of non-hexagonal rings, such as pentagons, heptagons, and octagons. Non-hexagonal rings, if incorporated into the lattice at low concentrations, may alter the tiling of a graphene lattice only slightly and locally. Since the incorporation of non-hexagonal rings causes a deviation from the hexagonal tiling of graphene, non-hexagonal rings will be referred to herein as “defects.” The frequency or concentration of defects in a lattice, expressed as the percentage of non-hexagonal rings to the total rings in the basal plane, is herein referred to as the lattice's “defectiveness” or “defect concentration.”

Higher concentrations of non-hexagonal rings may alter the tiling more significantly and ubiquitously. In fact, some lattice types may be comprised completely of non-hexagonal rings, such as pentagraphene, which has a regular pentagonal tiling. Other lattice structures may contain pentagons, hexagons, and heptagons in a randomized, vitreous tiling that is sometimes referred to as “amorphous graphene.” These non-hexagonal tilings may possess significantly different properties compared to graphene, such as higher lattice strain, different interlayer spacing and spacing distributions in multilayer lattice assemblies, and non-zero local curvature related to topological disorder. Controlling the introduction of non-hexagonal rings into a lattice (e.g. by introducing them into the lattice with controlled frequency) while the lattice is growing is referred to herein as “lattice engineering.” Carbon lattices made via lattice engineering processes are referred to as “engineered carbon lattices” or “engineered lattices.”

Lattice engineering may enable the tuning of a lattice's chemical potential energy, which may in turn make the addition of functional groups (herein referred to as “chemical functionalization” or “functionalization”) easier and more controllable. The “functionality” (i.e. a lattice's or multilayer structure's chemistry resulting from chemical functionalization) may affect how a particle interacts with other materials and media. To the extent that non-hexagonal lattice features might be induced to form at controllable concentrations during the lattice's growth, lattice engineering processes could facilitate the production of chemically functionalized lattices and lattice assemblies.

One of the most common functionalizations of nanostructured carbons is the covalent addition of oxygen-based functional groups, or “oxygen groups.” Oxygen groups preferentially added to the basal plane of graphene lattices include ether/epoxide (C—O—C), hydroxyl (C—OH), and carbonyl (C═O). On lattices with localized convexity, carboxyl and ether groups may be preferentially added to the basal plane (e.g. edgewall carboxylation of nanotubes). Carboxylation may result in the cleavage of C—C bonds and the formation of vacancies. A sufficient level of oxidation on graphene lattices results in what is commonly referred to as graphene oxide (“GO”). In many procedures for making graphene oxide, progressive oxidative etching of carbon lattices may generate an adsorbed layer of organic debris on the surface of a lattice. This debris, also referred to herein as “oxidized debris” (“OD”), may be physisorbed to a GO lattice. As such, the OD's oxygen groups may not be lattice-bound with respect to the underlying lattice. OD may be present on GO unless the lattice is subsequently base-washed, which results in desorption of the OD. Another effect of progressive oxidative etching may be to introduce or expand vacancies, as well as introducing other defects into the lattice.

Oxygen groups and oxidized debris on the GO lattice can affect the bonding and formation of the interface between the lattice and other materials. For instance, the debris on as-produced GO lattices has been shown to reduce the cross-linking density at the interface of GO and an epoxy matrix in epoxy nanocomposites. Reducing cross-linking density between the matrix and the lattice can impede the polymer's ability to transfer stress to the lattice, which may lower the modulus of the nanocomposite. Compared to epoxy nanocomposites made with GO decorated with OD, GO with its OD stripped away may enable a more densely crosslinked interface, resulting in a higher modulus.

Oxygen groups within the OD on GO typically comprise a significant percentage of the overall oxygen reported for GO. XPS analysis has shown that after removing the OD via base-washing, the C:O ratio is reduced from approximately 2:1 to 6:1. Hence, lattice-bound oxygen may often be much lower than the reported C:O ratios pertaining to GO would indicate. Base-washing and chemical reduction may also cause significant “de-epoxidation” of the lattice by converting lattice-bound epoxides into other oxygen groups. This conversion is undesirable when epoxide moieties are needed for certain applications, and for such applications removal of OD may be problematic.

In addition to the problem of lattice degradation and debris generation, the most common methods of oxidizing graphitic carbon, including the Brodie Method, Staudenmaier Method, Hoffman Method, and Hummer's method, as well as variations, have other significant disadvantages. First, they generally provide little control over the process, both in terms of the location and extent of oxidation. These methods oxidize via the reaction of strong, graphite-intercalating acids (typically H₂SO₄, HNO₃, or some combination thereof) and strong oxidizing agents (e.g., KMnO₄, KClO₃, NaNO₃, etc.) with a graphitic carbon feedstock. However, these materials may not be completely consumed, leading to corrosive waste-streams Second, the methods require hazardous chemicals and generate explosive and/or noxious gases (e.g., ClO₂, NO₂, N₂O₄, etc.). Therefore, they may require the production, storage, and consumption of hazardous reagents and produce hazardous waste.

Employing defective graphene lattices as feedstocks for oxidation to create GO with milder, more controllable processes has been explored. However, the literature shows that this can only be done with limited controllability and little industrial scalability. In one example, reactive defects were introduced into pre-treated graphite via electron-beam irradiation and the defective graphite was oxidized. However, the use of electron-beam radiation, as well as other aspects of the process, may not be easily scalable for mass production, and control of the oxidation was limited. Additionally, e-beam irradiation may not penetrate to specific layers in multilayer lattice assemblies. Therefore, there is still an unmet need for a controllable and mild process for producing carbon lattices with basal plane oxidation.

Lattice-engineering methods could offer new functionalization capabilities due to the ability to create more highly engineered lattice feedstocks that would allow functionalization to be more selective. For example, common feedstocks like graphite or graphitic nanoplatelets that are used for making graphene oxide may be comprised of carbon lattices with planar sides. Hence, the overall chemical reactivity of either side of a lattice may be the same. By contrast, single-wall nanotubes possess a concave endohedral and convex exohedral side. It has been shown that the convex side of a hexagonally tiled nanotube lattice is more chemically reactive than a hexagonally tiled planar lattice due to its strain, whereas the concave side of a hexagonally tiled nanotube lattice is less chemically reactive than a hexagonally tiled planar lattice. Hence, functionalization of single-wall nanotubes tends to be substantially one-sided, which is described herein as “monotopic” or “side-selective” functionalization. Two-sided functionalization is described herein as “ditopic” functionalization.

Unlike the specific case of nanotubes, wherein each side is 100% concave or convex, other lattices may exist in which each side exhibits localized concave and convex topographical features, or “sites.” Hence, the reactivity differences between concave and convex lattice curvatures, in addition to enabling side-selective functionalization, may also allow “site-selective” functionalization (i.e. functionalization effects that are specific to topographical sites). For example, an amorphous graphene lattice may possess a puckered topography, wherein each side exhibits a number of both concave and convex sites. If exposed to an oxidizing agent, these nanoscopic sites might be selectively not functionalized or functionalized based on their curvature, resulting in a mapping of functional groups that substantially corresponds to the lattice's topography.

Another type of selectivity might be based on the region(s) of the lattice being functionalized. For example, an engineered lattice might comprise a hexagonal, planar lattice nucleus, around which one or more amorphous, puckered new lattice regions have been concentrically grown. The nucleus region and new region(s) may possess different chemical reactivities, such that the lattice might be selectively not functionalized in the planar nucleus region and selectively functionalized in the puckered new lattice regions. This may result in a mapping of functional groups corresponding to the lattice's regional characteristics, or “region-selective” functionalization.

Another type of locational selectivity might pertain to specific “strata” (a “stratum” is defined herein as a distinct band within a multilayer structure comprising one or more adjacent layers) that are functionally distinct. For example, in an multilayer structure synthesized on a template or support, the development of the cell wall typically proceeds from the inside out—i.e. an inner band of lattices are grown next to the template first, then a middle band of lattices are grown over the inner band, and finally an outer band. As the wall forms, lattice engineering might be utilized to create distinct tilings associated with each stratum. This could be utilized to create functional surfaces (“surface” is defined herein as the external side of an external lattice region) that would change how a particle interacts with other media, but that would not affect the inner chemistry of the particle. For example, an oxidized surface might be electrically non-conducting, while the particle's inner lattices remained conductive. Stratum-selective oxidation is not possible with oxidation methods like Hummer's, in which a multilayer structure is intercalated by an oxidizing agent, which oxidizes not only the particle's surfaces, but also the lattices inside it.

In addition to locationally-selective functionalization, lattice engineering might allow “group-selective” functionalizations in which certain types of functional groups were formed preferentially. Functionalizing a lattice with dense, small topographical features may form carboxyls and ethers preferentially due to the dominance of convex-specific functionality and concave-specific nonfunctionality, and the relative deficiency of planar functionality. A highly carboxylated basal plane may result in more polar, hydrophilic surfaces and improved dispersibility in polar media.

Lattice engineered carbons may be utilized as feedstocks for selective functionalization. This may be particularly beneficial for oxidizing the surfaces of templated carbon particles selectively. Selective surface oxidation could render the particles more dispersible while leaving inner lattice structures intact and unoxidized.

Additional advantages and applications will be readily apparent to those skilled in the art from the following detailed description. The examples and descriptions herein are to be regarded as illustrative in nature and not restrictive.

### BRIEF DESCRIPTION OF THE FIGURES

Exemplary embodiments are described with reference to the accompanying figures, in which:

FIG. 1 is an illustration of the hexagonal lattice structure of graphene. The lattice is a single atom in thickness and is comprised of polyatomic ring structures. The ring structures form the lattice's tiling, which may be regular or irregular based on the types of rings present.

FIG. 2 is an illustration of a carbon lattice nucleus and a new growth region formed from the nucleus' edges over some interval of autocatalyzed lattice growth. Together these comprise an engineered lattice structure, which may possess locally varied tilings.

FIG. 3 is an illustration of the basic features of a lattice. This includes the lattice's edges, which comprise the one-dimensional terminus of the lattice, the lattice's sides, which comprise the two surfaces formed by any region, and a lattice region, which is some localized subset of the lattice's carbon atoms.

FIG. 4 is an illustration of some hypothetical multilayer structures, each of which have features with two or more layers. The templated multilayer structure shows a template and a cross-section of the multilayer wall formed around the template.

FIG. 5 Scanning Electron Microscopy (SEM) images of samples A1-A4 after extraction of the MgO template.

FIG. 6 Transmission Electron Microscopy (TEM) images of samples A1, A3 and A4 after extraction of the MgO template showing the multilayer structure's cross section or wall thickness.

FIG. 7 Raman spectra of samples A1-A4 prior to extraction of the MgO template.

FIG. 8 Thermogravimetric analysis (TGA) curves of oxidized samples A1-A4. Two oxidation protocols of 20 hrs and 40 hrs were implemented. All TGA curves were performed (at a temperature ramp rate of 20° C./min) in argon.

FIG. 9 C/O ratios extracted from X-ray photoelectron spectroscopy (XPS) analysis on Samples A3, A3 80xBT-2 hr, and A3 80xBT-20 hr showing 0/C ratio (A) and a breakdown of the carbon-oxygen moieties (B).

FIG. 10 SEM images of sample A3 and oxidized versions of the same for different oxidation times of 2 hrs and 20 hrs.

FIG. 11 Raman spectra of samples A1, A3, and B1 prior to extraction of the MgO template.

FIG. 12 SEM images of samples A1, A3, and B1 after extraction of the MgO template.

FIG. 13 Transmission Electron Microscopy (TEM) images of samples A1, A3 and B1 after extraction of the MgO template showing the multilayer structure's cross section or wall thickness.

FIG. 14 TGA curves of oxidized variants of samples A1, A3, and B. Two oxidation protocols of 20 hrs and 40 hrs were used. All TGA curves were performed (at a temperature ramp rate of 20° C./min) in argon.

FIG. 15 Image of B2-Ox and B3-Ox after resuspension in water to show the differences in their wetting behavior.

FIG. 16 Schematic showing a typical reaction between a silane and hydroxyl group via a two-step hydrolysis and condensation reaction mechanism.

FIG. 17 Image of C0-Ox and C0-Ox-OTES (pre and post agitation) showing the change it wetting behavior of the functionalized carbon.

FIG. 18 TGA curves of C0-Ox and C0-Ox-OTES. All TGA curves were performed (at a temperature ramp rate of 20° C./min) in argon.

FIG. 19 SEM images of samples carbon black control (D0) and autocatalytically grown carbons at low (D1) and high temperatures (D2), respectively.

FIG. 20 TGA curves of Samples D0, D1, and D2 (A) showing the different thermal nature of the additional carbon grown on carbon black. Also shown are oxidized version D1-Ox and D2-Ox, again showing the differing behavior post-oxidation (B). All TGA curves were performed (at a temperature ramp rate of 10° C./min) in air.

FIG. 21 TGA curves of Samples E2 40xABT-20 hr (Control, BW and BW-RA) showing the percentage mass loss (A) and normalized derivative weight (B). All TGA curves were performed (at a temperature ramp rate of 20° C./min) in argon.

FIG. 22 TGA curves of Samples E0, E1 and E2 after 24 hr Piranha treatment showing the percentage mass loss. All TGA curves were performed (at a temperature ramp rate of 20° C./min) in argon.

FIG. 23 TGA curves of Samples E0, E1 and E2 after 24 hr Piranha treatment showing the normalized derivative weight. All TGA curves were performed (at a temperature ramp rate of 20° C./min) in argon.

FIG. 24 TGA curves of Samples E1 and E2 after 24 hr Piranha treatment and base-washing showing the normalized derivative weight. All TGA curves were performed (at a temperature ramp rate of 20° C./min) in argon.

FIG. 25 TGA curves of Samples E0 and E2 after 60 hr APS treatment showing the percentage mass loss. All TGA curves were performed (at a temperature ramp rate of 20° C./min) in argon.

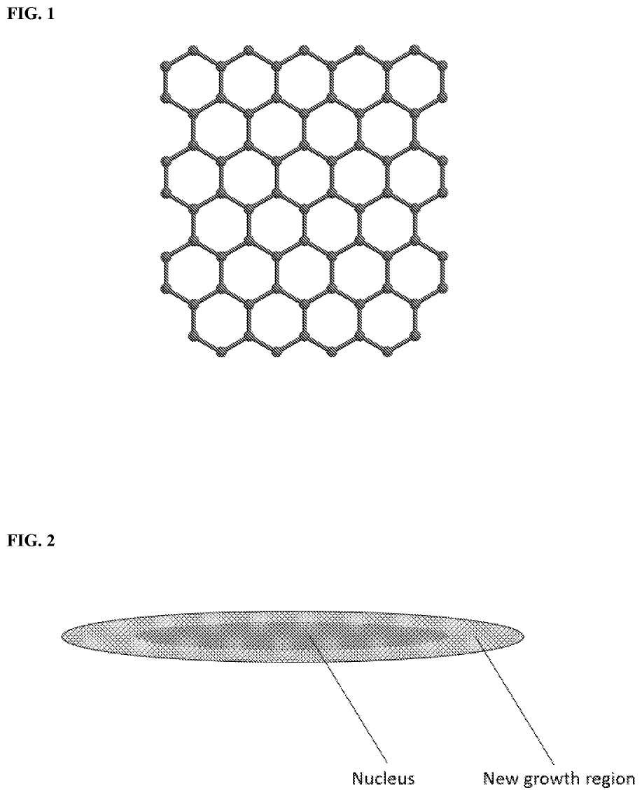

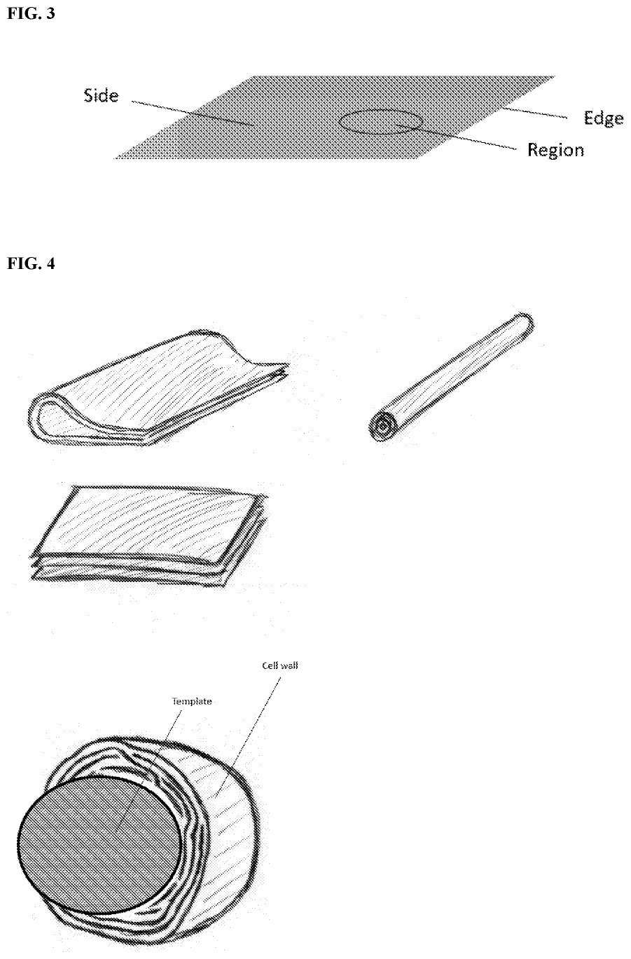

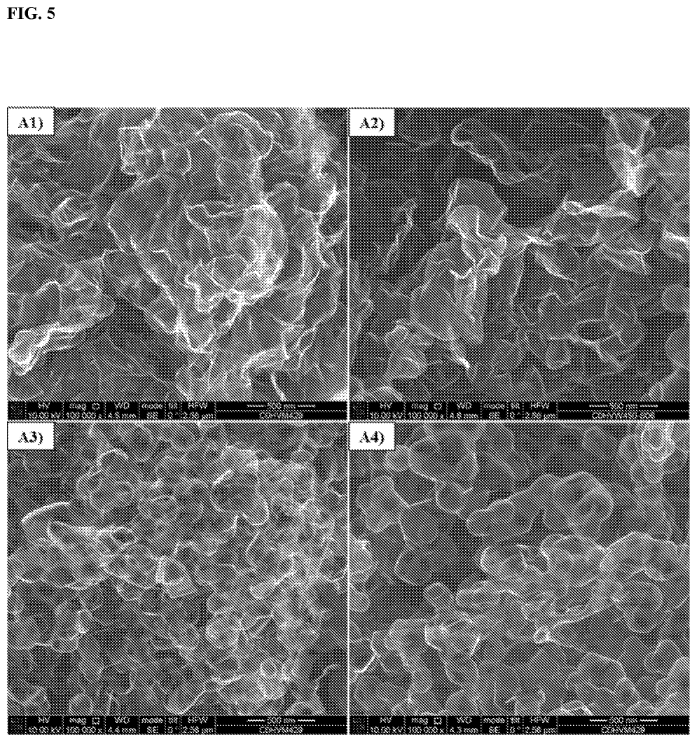

### DETAILED DESCRIPTION

The following description, including the described experimental results, demonstrates use of autocatalyzed lattice growth to engineer lattices with a controllable density of non-hexagonal rings and lattices with locally varied molecular tilings. The resulting lattice-engineered lattices may then be chemically functionalized. Such autocatalyzed lattice growth can be obtained under several different conditions without substantially deviating from the essence of the process described herein.

Described herein is a chemically functionalized carbon lattice formed by a process comprising heating a carbon lattice nucleus in a reactor to a temperature between room temperature and 1500° C. The process also may comprise exposing the carbon lattice nucleus to carbonaceous gas to adsorb carbon atoms in the carbonaceous gas onto edges of the carbon lattice nucleus, covalently bond the adsorbed carbon atoms to one another in polyatomic rings, a portion of the polyatomic rings comprising non-hexagonal rings, covalently bond the polyatomic rings to one another in one or more new lattice regions extending off the carbon lattice nucleus thereby forming an engineered lattice incorporating the non-hexagonal rings, exposing a portion of the engineered lattice to one or more chemicals to bond at least one of a functional group and molecule to the engineered lattice.

In some embodiments, the process further may comprise nucleating the carbon lattice nucleus within the reactor. The carbon lattice nucleus may rest on a template or support during the process. The template or support may comprise an inorganic salt. The template or support may comprise a carbon lattice within at least one of a templated carbon, carbon black, graphitic carbon, and activated carbon particle. The template or support may direct the formation of the engineered lattice. The carbonaceous gas may comprise organic molecules. The engineered lattice may comprise a portion of a multilayer lattice assembly. The non-hexagonal rings may comprise at least one of 3-member rings, 4-member rings, 5-member rings, 7-member rings, 8-member rings, and 9-member rings. The functionalized non-hexagonal rings may create an amorphous or haeckelite lattice structure with non-planar lattice features.

The process may further comprise adjusting at least one of a frequency and tiling of non-hexagonal rings formed within the engineered lattice by selecting conditions under which rings are formed. The selected conditions may comprise at least one of: species of carbonaceous gases, partial pressures of carbonaceous gases, total gas pressure, temperature, and lattice edge geometry. The process may comprise substantially maintaining the conditions while the new lattice regions are formed. The process may comprise substantially changing the conditions while the new lattice regions are formed. Changing the conditions may comprise heating or cooling of the new lattice regions while the new lattice regions are formed. Changing the conditions may comprise conveying the engineered lattice through two or more distinct reactor zones, each distinct reactor zone having distinct local conditions while the new lattice regions are formed. Conveying the engineered lattice through the two or more distinct local conditions may comprise conveying the engineered lattice through a gradient in local conditions while the new lattice regions are formed. The distinct local conditions may comprise distinct levels of thermal energy. The distinct local conditions may comprise distinct local temperatures ranging from 300° C. to 1100° C. The conveying of the engineered lattice may comprise conveying the engineered lattice in a moving or fluidized bed. A concentration of non-hexagonal ring structures may be substantially the same throughout the engineered lattice.

A concentration of non-hexagonal ring structures in one region of the engineered lattice may be substantially different from the concentration of non-hexagonal ring structures in another region of the engineered lattice. The engineered lattice may comprise a surface of a multilayer assembly of engineered lattices. The non-planar features within the engineered lattice may increase the chemical reactivity of the lattice. A Raman spectra of the engineered lattice or multilayer assembly of engineered lattices may exhibit an IT/IG peak intensity ratio below 0.25. A Raman spectra of the engineered lattice or multilayer assembly of engineered lattices may exhibit an IT/IG peak intensity ratio between 0.25 and 0.50. A Raman spectra of the engineered lattice or multilayer assembly of engineered lattices may exhibit an IT/IG peak intensity ratio between 0.50 and 0.75. A Raman spectra of the engineered lattice or multilayer assembly of engineered lattices may exhibit an IT/IG peak intensity ratio above 0.75. An interlayer d-spacing as determined by XRD may exhibit a peak intensity at between 3.45 Å and 3.55 Å. An interlayer d-spacing as determined by XRD may exhibit a peak intensity at between 3.55 Å and 3.65 Å. Exposing a portion of the engineered lattice to one or more chemicals may comprise exposing at least two sides of the exposed portion of the engineered lattice. Exposing a portion of the engineered lattice to one or more chemicals may comprise exposing no more than one side of the exposed portion of the engineered lattice. An unexposed side of the engineered lattice may be physically occluded by an adjoining support. The adjoining support may comprise one or more carbon lattices. Exposing a portion of the engineered lattice to one or more chemicals may comprise covalently adding functional groups to the exposed portion of the engineered lattice. Exposing a portion of the engineered lattice to one or more chemicals may comprise mechanically agitating the engineered lattice in the presence of the chemicals. Bonding at least one of a functional group and molecule to the engineered lattice may comprise forming covalent bonds between lattice-bound carbon atoms and at least one of the following: oxygen atoms, nitrogen atoms, sulfur atoms, hydrogen atoms, and halogen atoms. Bonding at least one of a functional group and molecule to the engineered lattice may comprise forming covalent bonds between lattice-bound carbon atoms and oxygen atoms. Bonding at least one of a functional group and molecule to the engineered lattice may comprise forming covalent bonds between lattice-bound carbon atoms and nitrogen atoms in the form of quaternary nitrogen cations.

At least one of the one or more chemicals may comprise an acid. The acid may comprise oleum, sulfuric acid, fuming sulfuric acid, nitric acid, hydrochloric acid, chlorosulfonic acid, fluorosulfonic acid, alkylsulfonic acid, hypophosphorous acid, perchloric acid, perbromic acid, periodic acid, and combinations thereof. The acid may comprise an intercalating agent that intercalates two or more lattices in a multilayer lattice assembly. At least one of the one or more chemicals may be an oxidizing agent. The oxidizing agent may comprise at least one of the group consisting of peroxides, peroxy acids, tetroxides, chromates, dichromates, chlorates, perchlorates, nitrogen oxides, nitrates, nitric acid, persulfate ion-containing compounds, hypochlorites, hypochlorous acid, chlorine, fluorine, steam, oxygen gas, ozone, and combinations thereof. The oxidizing agent may comprise at least one of a peroxide, hypochlorite, and hypochlorous acid. The oxidizing agent may comprise an acidic solution. The oxidizing agent may comprise a basic solution. The process may comprise forming at least one of the following functional groups within the basal plane of the exposed portion of the engineered lattice: carboxyls, carbonates, hydroxyls, carbonyls, ethers, and epoxides. The process may comprise selectively forming one or more types of functional groups based on at least one of the following factors: the local defect structure of the exposed lattice, the local curvature of the exposed lattice, the pH of the oxidizing solution, the concentration of the oxidizing solution, the temperature of the oxidizing solution, the oxidizing species within the oxidizing solution, the duration of the lattice's exposure to the oxidizing solution, the ion concentration of the oxidizing solution. Selectively forming one or more types of functional groups may comprise selectively forming carboxylic functional groups. Forming carboxylic functional groups may introduce vacancies within the basal plane of the carbon lattice. The process may comprise etching the vacancies to create nanoscopic holes within the basal plane. Exposing a portion of the engineered lattice to one or more chemicals may comprise progressive oxidative etching. The progressive oxidative etching of the lattice may produce organic debris. The organic debris may be adsorbed to the surface of a multilayer lattice assembly. The progressive oxidative etching of the lattice may produce substantially no organic debris. An atomic ratio of carbon to oxygen on an exposed side of the engineered lattice may be between 1:1 and 2:1. An atomic ratio of carbon to oxygen on an exposed side of the engineered lattice may be between 2:1 and 4:1. An atomic ratio of carbon to oxygen on an exposed side of the engineered lattice may be between 4:1 and 6:1. An atomic ratio of carbon to oxygen on an exposed side of the engineered lattice may be between 6:1 and 8:1. An atomic percentage of nitrogen in the engineered lattice may be greater than 5%. An atomic percentage of nitrogen in the engineered lattice may be between 1% and 5%.An atomic percentage of sulfur in the engineered lattice may be greater than 5%. An atomic percentage of sulfur in the engineered lattice may be between 1% and 5%.

The process may comprise exposing the engineered lattice to a basic solution after exposing it to the oxidizing agent. The process may comprise exposing the engineered lattice to a basic solution to increase a total mass of labile groups, as determined by thermogravimetric analysis of the functionalized carbon in an argon atmosphere, by more than 50%. The total mass of labile groups on the oxidized carbon may increase by between 25% and 50% after being exposed to a basic solution, as determined by thermogravimetric analysis of the functionalized carbon in an argon atmosphere. Exposing the carbon to a basic solution may comprise deprotonating carboxyl groups to form carboxylate groups. The process may comprise exposing the engineered lattice to an acidic solution. Exposing the engineered lattice to an acidic solution may comprise protonating carboxylate groups to form carboxyl groups. The process may comprise covalently bonding molecules to the chemically functionalized carbon lattice. The molecules may comprise a coupling agent. The coupling agent may comprise siloxane or polysiloxane.

Some embodiments include a method of forming a chemically functionalized carbon lattice comprising heating a carbon lattice nucleus in a reactor to a temperature of between room temperature and 1500° C. The method comprises exposing the carbon lattice nucleus to carbonaceous gas to adsorb carbon atoms in the carbonaceous gas onto edges of the carbon lattice nucleus, covalently bond the adsorbed carbon atoms to one another in polyatomic rings, a portion of the polyatomic rings incorporating non-hexagonal rings, covalently bond the polyatomic rings to one another in one or more new lattice regions extending off the carbon lattice nucleus thereby forming an engineered lattice comprising the non-hexagonal rings The method further comprises exposing a portion of the engineered lattice to one or more chemicals to bond at least one of a functional group and molecule to the engineered lattice.

The experiments disclosed herein conducted CVD under ambient pressure. Gases used during CVD included methane (CH₄), propylene (C₃H₆), and argon (Ar). Some experiments used MgO templates. Such templates were created from magnesium carbonate that was sourced from Akrochem (Light Magnesium Carbonate or L-MgCO₃). Hydrochloric acid (HCl) sourced from Shape Chemicals was used for acid extraction of the MgO templates.

An MTI rotary tube furnace with a maximum programmable temperature of 1200° C. and a quartz tube were used for all CVD experiments. The furnace was outfitted and operated according to the numbered schema described below.

In Scheme 1, the furnace was kept level. Sample powder was loaded directly into a quartz tube with an 100 mm outer diameter and pushed into its central region, located within the furnace's heating zone. Ceramic blocks were inserted into the tube and placed on each side of the heating zone. Glass wool was used to fix the position of the ceramic blocks. The tube was outfitted with stainless steel flanges, an upstream gas feed inlet, and a downstream gas outlet. The quartz tube was rotated at 2.5 or 10 RPM throughout the heating of the furnace, the CVD process, and the cooling of the furnace.

In Scheme 2, the furnace and a quartz tube (with a 60 mm outer diameter) were both tilted/inclined. The tube was rotated. A “Schenk Accurate” reciprocating auger feeder was inserted into the elevated end of the tube, and the air gap between the outer diameter of the feeder and the inner diameter of the quartz tube was sealed with silicone foam washers that could rotate freely. The auger feeder metered powder continuously into the elevated end of the quartz tube. The downstream end of the tube was left open to the air. The auger feeder was modified upstream of the quartz tube with a gas feed inlet upstream in order to flow the process gas through the auger feeder.

In Scheme 3, the furnace was kept level. Powder was placed in ceramic boats. The boats were then placed in a quartz tube (with a 60 mm outer diameter) and pushed into the tube's central region (i.e., within the furnace's heating zone). The quartz tube was not rotated. One end of the tube was outfitted with stainless steel flanges and a gas feed inlet. The opposite end of the tube was left open to the air.

All Raman spectroscopic characterization was performed using a ThermoFisher DXR Raman microscope equipped with a 532 nm excitation laser. All TGA characterization was performed on a TA Instruments Q600 TGA/DSC.

Raman spectroscopy is commonly used to characterize the lattice structure of carbon. Three main spectral features are typically associated with sp²-bonded carbon: the G band (at 1585 cm⁻¹), the G′ band (alternatively called the “2D band,” which lies between 2500 and 2800 cm⁻¹), and the “D band” (which lies between 1200 and 1400 cm⁻¹). The G band results from in-plane vibrations of sp²-bonded carbons and, therefore, can provide a Raman signature for sp² carbon crystals. In contrast, the D band results from out-of-plane vibrations attributed to structural defects in the carbon. A higher D band indicates a greater fraction of broken sp² bonds, implying a higher degree of sp³ bonds. Therefore, the D band is associated with lattice disorder and the ratio of D to G bands intensities provides a measure of defects. However, accurate D band measurements become difficult to obtain as disorder increases beyond a certain threshold because the D peak broadens and decreases in height. When this broadening happens, the trough between the D and G peaks becomes more shallow. For this reason, the present disclosure defines and uses a fourth feature, the “T band,” the trough between the D peak and the G peak, to ascertain disorder in lieu of the D band. The depth the T band trough is related to the degree of order. Measuring the T band trough intensity, denoted herein as “T band intensity,” can indicate broadening of the D peak. The T band intensity is defined herein as the local minimum intensity value occurring between the wavenumber associated with the D peak and the wavenumber associated with the G peak.

The intensities of the G, 2D, D, and T bands are designated herein as I_{G}, I_{G′} (or I_{2D}) I_{D}, and I_{T}, respectively. The I_{G′}/I_{G} (or I_{2D}/I_{G}) peak ratio can be understood as the proportion of sp² carbons contributing to two-dimensional structuring in the sample. As discussed above, the I_{D}/I_{G} ratio can be understood as a measure of the proportion of non-sp² carbons to sp² carbons and be related to defect concentration. For highly disordered carbons, the I_{T}/I_{G} ratio has a similar physical interpretation as I_{D}/I_{G}, insomuch as it reflects the broadening of the D peak and relates to defect concentration.

25 distinct point Raman spectra were measured for each sample. The measurements were made over a 5×5 point rectangular grid with point-to-point intervals of 20 μm. The 25 distinct point spectra were then averaged to create a composite spectrum. The peak intensity ratios reported for each sample all derive from the sample's composite spectrum.

Experiments A-E were performed to explore the control over and effects of defect concentration and the oxidation of defects. Each experiment is described in detail below.

### Experiment A—Procedure

Experiment A explores the effect of a metal oxide template (MgO), as well as other parameters like hydrocarbon species and reactor temperature on lattice structure and reactivity.

Metal oxide powders catalyze the thermal decomposition of carbonaceous gases, leading to in-situ nucleation of multi-ring (i.e., “polycylic”) carbon structures on surfaces of the metal oxide particles. The lattice nuclei may provide the seeds for autocatalyzed lattice growth, as disclosed in PCT/US17/17537. If growth continues long enough, the carbon lattices may form a multilayer structure at least partially covering the surface of the metal oxide particle, which may act as a template and/or a catalyst. The metal oxide template may then be extracted from the carbon shell resulting in a templated multilayer structure.

In Experiment A, four carbon samples (A1-A4) were synthesized via an MgO template-directed CVD process using the furnace Scheme 1 described above. All gases used in the synthesis were sourced from Praxair. The MgO templates were produced by calcining L-MgCO₃ at a temperature of 1050° C. for 2 hours, resulting in a powder of polyhedral particles (PH-MgO).

For Sample A1, a mixture of CH₄ and Ar was employed as the feed gas. The quartz tube was loaded with 300 g of PH-MgO powder. Subsequently, tube was closed and rotated at 2.5 RPM. After initiating a 500 sccm Ar flow, the furnace temperature was ramped from room temperature to 1050° C. over a 50 minute period. It was then was maintained at 1050° C. for 30 minutes. During heating Ar gas flow was sustained. Next, a 160 sccm CH₄ flow was initiated while maintaining Ar flow for 60 minutes. CH₄ flow was then discontinued and the furnace allowed to cool to room temperature under continuous Ar flow. The MgO was then extracted by acid-etching with HCl resulting in a slurry of carbon in an aqueous magnesium chloride (MgCl₂) brine. The carbon was then filtered from the brine, rinsed three times with deionized water and collected as an aqueous paste (A1-Aq). A solvent exchange process replaced the water with acetone, resulting in an acetone paste. The acetone paste was then evaporatively dried to form a dry carbon powder A1.

For Sample A2, a mixture of CH₄ and Ar was employed as the feed gas. The quartz tube was loaded with 300 g of PH-MgO powder then was closed and tube rotation at 2.5 RPM was started. After initiating a 500 sccm Ar flow, the furnace was heated from room temperature to 1050° C. over a period of 50 minutes. Subsequently it was maintained at 1050° C. for 30 minutes. Ar flow was sustained during all heating. Next, a 1920 sccm CH₄ flow was initiated while maintaining Ar flow. This was continued for 15 minutes. The CH₄ flow was then discontinued, and the furnace was allowed to cool to room temperature under continued Ar flow. The MgO was extracted by acid-etching with HCl under excess acid conditions, resulting in a slurry of carbon in an aqueous MgCl₂ brine. The carbon was filtered from the brine, rinsed three times with deionized water, and collected as an aqueous paste (A2-Aq). A solvent exchange process was then used to replace the water with acetone resulting in an acetone/carbon paste. The acetone paste was then evaporatively dried to form a dry carbon powder A2.

For Sample A3, a mixture of C₃H₆ and Ar was employed as the feed gas. The quartz tube was loaded with 300 g of PH-MgO, then closed and tube rotation at 2.5 RPM was started. After initiating a 500 sccm Ar flow, the furnace was heated from room temperature to a temperature setting of 750° C. over 30 minutes, then maintained at 750° C. for 30 minutes, all under sustaining Ar flow. Next, a 270 sccm C₃H₆ flow was initiated while holding Ar flow unchanged. This was continued for 30 minutes. The C₃H₆ flow was then discontinued, and the furnace was allowed to cool to room temperature under continued Ar flow. The MgO was extracted by acid-etching with HCl under excess acid conditions, resulting in a slurry of carbon in an aqueous MgCl₂ brine. The carbon was filtered from the brine, rinsed three times with deionized water, and collected as an aqueous paste (A3-Aq). A solvent exchange process was then used to replace the water with acetone, resulting in an acetone/carbon paste. The acetone paste was then evaporatively dried to form a dry carbon powder A3.

For Sample A4, a mixture of C₃H₆ and Ar was employed as the feed gas. The quartz tube was loaded with 300 g of PH-MgO, then closed and rotated at 2.5 RPM. After initiating a 500 sccm Ar flow, the furnace was heated from room temperature to a temperature setting of 650° C. over 30 minutes, then maintained at 650° C. for 30 minutes, all under sustained Ar flow. Next, a 270 sccm C₃H₆ flow was initiated while holding Ar flow unchanged. This was continued for 60 minutes. The C₃H₆ flow was then discontinued, and the furnace allowed to cool to room temperature under continued Ar flow. The MgO was extracted by acid-etching with HCl under excess acid conditions, resulting in a slurry of carbon in an aqueous MgCl₂ brine. The carbon was then filtered from the brine, rinsed three times with deionized water, and collected as an aqueous paste (A4-Aq). A solvent exchange process was then used to replace the water with acetone, resulting in an acetone/carbon paste. The paste was then evaporatively dried to form a dry carbon powder A4.

Next, each of the aqueous pastes was subjected to a series of measurements to evaluate the effects of mild oxidation on the carbons. Sodium hypochlorite solution (˜13 wt % NaOCl) was chosen as the oxidizing agent. For each reaction, a 0.5 wt % concentration of carbon and ˜5.3 wt % concentration of NaOCl were used, as shown in Table 1 below:

TABLE 1

| | Oxidation of Carbons A1-A4 | | | |
|---|---|---|---|---|
| | Carbon A1 | Carbon A2 | Carbon A3 | Carbon A4 |
| Carbon (g) | 0.25 | 0.25 | 0.25 | 0.25 |
| 13 wt % NaoOCl | 20.00 | 20.00 | 20.00 | 20.00 |
| Solution (g) | | | | |
| Aqeuous Carbon | 4.91 | 6.02 | 14.45 | 16.67 |
| Paste (g) | | | | |
| Additional H2O (g) | 24.34 | 23.23 | 14.80 | 12.58 |
| Carbon Loading | 0.5% | 0.5% | 0.5% | 0.5% |
| (wt %) | | | | |

The reactions were run for 20 hours, after which aliquots of 24 grams (containing ˜0.12 grams of Sample carbon) were collected. The remaining solutions were allowed to react for another 20 hours (a total reaction time of 40 hours). The solutions sampled at the 20-hour and 40-hour marks were filtered, followed by washing the carbon retentate with DI water and re-suspending in a 0.2M HCl solution. The acidic solution was stirred for 10 minutes, then filtered and washed with DI water to obtain an aqueous paste of oxidized carbon. A solvent exchange process was then used to replace the water with acetone, resulting in an acetone paste. The paste was then evaporatively dried at 60° to form an oxidized carbon powder. Carbons oxidized using this protocol were labelled “80xBT-20 hr” or “80xBT-40 hr,” based on whether they were run for 20 hours or 40 hours.

### Experiment A—Materials Characterization and Analysis

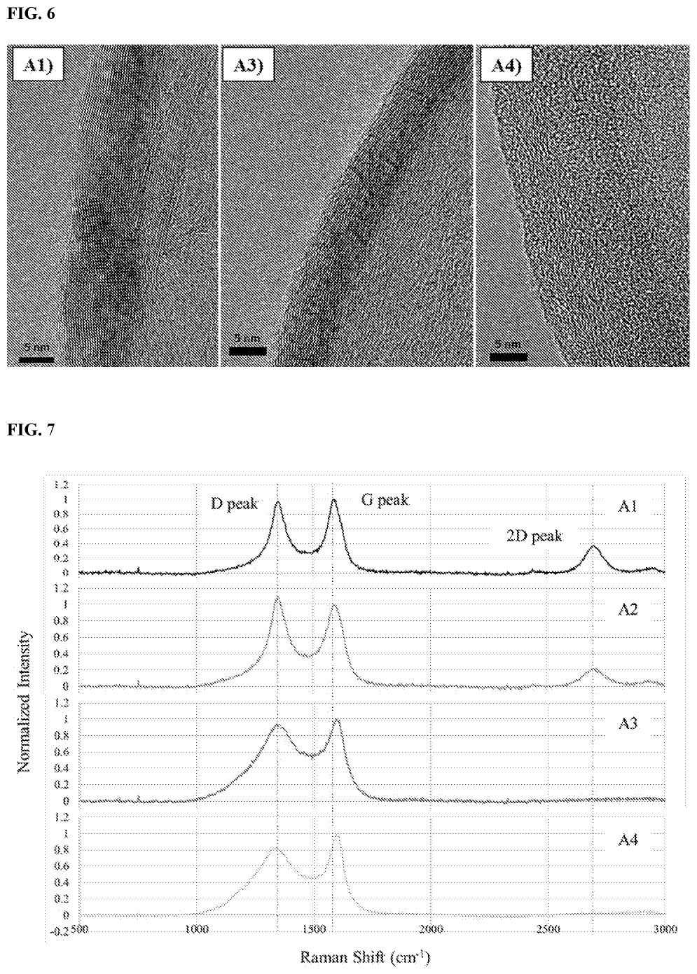

The carbon yield, defined herein as the weight percentage of carbon in the as-synthesized powder of MgO and C, was measured by performing ash tests on the dark grey powders retrieved after the CVD process. Yield was measured after CVD rendered the originally white MgO powder dark grey, the color change indicating formation of carbon. Similar yields, ranging from 1.71% to 2.31%, were obtained in each carbon synthesis procedure by varying temperatures, flow rates, growth times, and hydrocarbon species. SEM images of samples A1-A4 are shown in FIG. 5 and TEM images of A1, A3 and A4 are shown in FIG. 6. In the TEM images, the lattice fringes of Sample A1 can be observed to be more planar and aligned than the lattice fringes of A3 and A4. This indicates a largely hexagonal sp² tiling with relatively few out-of-plane deformations caused by defects. Of the three samples, A4 is the most non-planar, consistent with the highest concentration of defects throughout the basal plane, which cause out-of-plane deformations and lend the sp² triangular bonds some tetrahedral character. This strain should increase the lattice's potential energy and chemical reactivity. Table 2 summarizes the yields:

TABLE 2
Yield and Parametric Combination Data for Samples A1-A4

| | A1 | A2 | A3 | A4 |
|---|---|---|---|---|
| Substrate | L-MgCO3 | L-MgCO3 | L-MgCO3 | L-MgCO3 |
| | 1050 C.-2 hrs | 1050 C.-2 hrs | 1050 C.-2 hrs | 1050 C.- |
| | | | | 2 hrs |
| Substrate | 300 | 300 | 300 | 300 |
| mass (g) | | | | |
| Rotary Bed | Yes | Yes | Yes | Yes |
| No. of | 1 | 1 | 1 | 1 |
| Growth Steps | | | | |
| Growth | 1050 | 1050 | 750 | 650 |
| Temperature | | | | |
| (° C.) | | | | |
| Growth Time | 60 | 15 | 30 | 60 |
| (mins) | | | | |
| Gas Type-Flow | CH₄-133 | CH₄-1733 | C₃H₆-250 | C₃H₆-250 |
| rate (sccm) | | | | |
| Clinker Ash or | 1.71% | 1.88% | 2.31% | 2.25% |
| Yield (%) | | | | |

The defect concentration in the carbon prior to template extraction was analyzed via Raman spectroscopy. The spectra for these samples are shown in FIG. 7, and the spectral peak ratios are shown below in Table 3:

TABLE 3
Raman Peak Ratios for Samples A1-A4

| | A1 | | A2 | | A3 | | A4 | |
|---|---|---|---|---|---|---|---|---|
| | Average | Std. Dev. | Average | Std. Dev. | Average | Std. Dev. | Average | Std. Dev. |
| ID/IG | 0.970 | 6.85% | 1.067 | 5.04% | 0.960 | 3.47% | 0.834 | 3.45% |
| IG′/IG | 0.416 | 12.46% | 0.254 | 9.39% | 0.111 | 20.51% | 0.068 | 18.09% |
| IT/IG | 0.170 | 23.66% | 0.259 | 8.71% | 0.432 | 7.67% | 0.395 | 3.96% |

Raman spectral analysis shows that I_{T}/I_{G} (defect concentration) is substantially higher for samples A3 and A4, produced at 750° C. and 650° C., respectively, than for samples A1 and A2, produced at 1050° C. This suggests that, all else being equal, samples produced at higher temperature (i.e., A1 and A2 produced at 1050° C.) have lower defect concentration (i.e., lower I_{T}/I_{G}) than the samples produced at lower temperatures. This is consistent with the TEM analysis. Comparing the Raman analysis for A1 and A2 also shows that, for samples produced at the same temperature (i.e., 1050° C.), lower gas flow rate lead to a lower defect concentration (i.e., lower I_{T}/I_{G} for the lower flow rate sample, A1). Taken together, these results suggest that higher temperatures and lower hydrocarbon flow rates are conducive to the synthesis of more ordered, less defective carbons, consistent with results described in PCT/US17/17537. Higher hydrocarbon flow rates may increase the rate of autonucleation (i.e. the carbon-catalyzed nucleation of new carbon lattices). This would reduce the average lattice size and increase the density of edge states, reducing order in Raman spectra. When flooded with hydrocarbon molecules, the kinetics of lattice edge growth may speed up to the point that the formation of non-hexagonal rings increases. This may also result in reduced basal plane order.

Carbons synthesized via template-directed CVD often exhibit Raman spectra indicative of a high defect concentration. High defect concentrations can be caused by the high nucleation density that typically occurs on templates. Lattice assemblies formed with numerous lattice nuclei with hexagonal tilings generally exhibit highly defective spectra due to the high density of edges. Large lattices with non-hexagonal tilings may possess defective spectra due to the significant concentration of non-hexagonal rings within their basal plane. For these reasons, the high defect concentration indicated by the Raman spectra pertaining to most of the samples in Experiment A do not independently prove the existence of lattices with non-hexagonal rings. In order to confirm non-hexagonal lattice tiling, the Raman results can be compared with results from other characterization methods such as TGA.

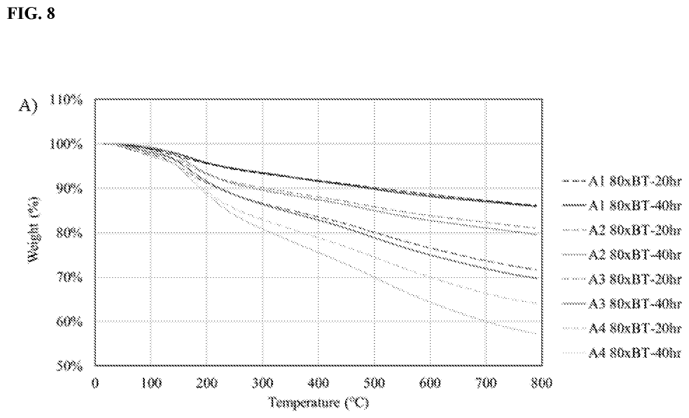

TGA of the samples oxidized with sodium hypochlorite, shown in FIG. 8 confirms the level of oxygen moieties in the samples. When exposed to heat under Ar, the oxidized carbon samples exhibit a mass loss primarily attributed to the evolution of oxygen-containing moieties. The TGA mass loss for each of the oxidized carbons samples between the temperature of 100° C. and 750° C. is shown in Table 4:

TABLE 4
TGA mass loss for Samples A1-A4 and their oxidized variants

| | A1 | A2 | A3 | A4 |
|---|---|---|---|---|
| % Mass remaining at 100° C. | >99.5% | >99.5% | >99.5% | >99.5% |
| % Mass remaining at 750° C. | >98.0% | >98.0% | >98.0% | >98.0% |
| % Mass loss between 100° C.-750° C. | <2.0% | <2.0% | <2.0% | <2.0% |
| | A1 80xBT-20 hr | A2 80xBT-20 hr | A3 80xBT-20 hr | A4 80xBT-20 hr |
| % Mass remaining at 100° C. | 99% | 98% | 98% | 98% |
| % Mass remaining at 750° C. | 87% | 82% | 72% | 65% |
| % Mass loss between 100° C.-750° C. | 12% | 17% | 25% | 33% |
| | A1 80xBT-40 hr | A2 80xBT-40 hr | A3 80xBT-40 hr | A4 80xBT-40 hr |
| % Mass remaining at 100° C. | 99% | 99% | 98% | 97% |
| % Mass remaining at 750° C. | 86% | 80% | 71% | 58% |
| % Mass loss between 100° C.-750° C. | 13% | 19% | 27% | 39% |

For Sample A1, the Raman spectra indicated a relatively low defect concentration and, therefore, a high degree of hexagonal tiling. Therefore, the oxidation resulting from exposure to sodium hypochlorite solution was minimal. Similar to other graphitic carbon nanostructures, the chemical stability of the hexagonal basal planes and the lack of accessible lattice edges precluded extensive oxidation under the relatively mild oxidation process used to create the sample. In Sample A2, oxidation measured by TGA was slightly greater. This may be due to a smaller lattice size distribution and a greater number of accessible edge defects arising from auto-nucleation of small lattices on the surfaces of the lattice assemblies.

TEM analysis and Raman spectra show samples A3 and A4 to be significantly more defective (as evidenced by their higher I_{T}/I_{G} in Table 3) than samples A1 and A2. The TGA data show that, correspondingly, A3 and A4 also exhibit a greater degree of oxidation (higher mass loss, as shown in Table 4). The increased oxidation was surprising based on the higher yield of these carbon shells relative to Samples A1 and A2 (Table 2). Since the MgO template was essentially identical for each of the four samples (A1-A4), the higher yield for A3 and A4 suggests a thicker multilayer structure with proportionally less surface area exposed to the oxidizing agent. In the absence of intercalation by the oxidizing agent, oxidation should only be happening on the multilayer structure's surface. Hence, reduced surface area would normally suggest a lower degree of oxidation (i.e. less oxygen per unit mass of the structure). Even if the multilayer structures in samples A3 and A4 were comprised of highly reactive lattice structures, they were not expected to be intercalated by the sodium hypochlorite solution, and oxidation of the assembly surface would be expected to be lower.

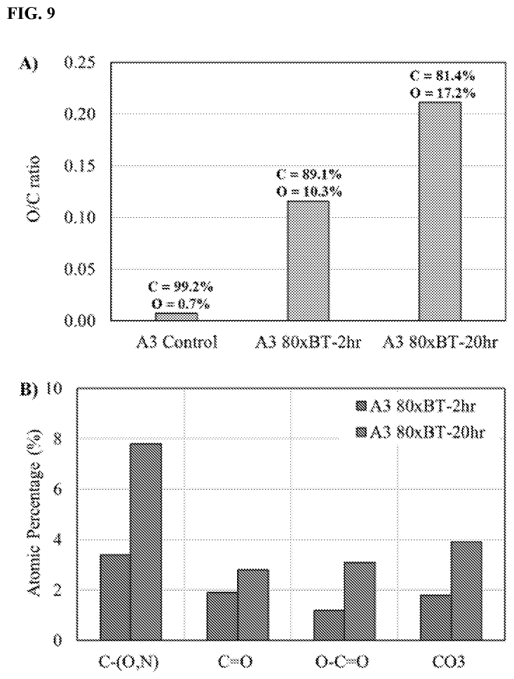

The relatively high degree of mass loss in Samples A3 and A4 shown in Table 4 suggests that the lattice basal planes were oxidized. To verify the basal plane oxidation, sample A3 was analyzed via XPS both prior to oxidation and then again after 2 and 20 hours after oxidization. FIG. 9A shows that, while the A3 sample prior to functionalization showed negligible oxygen (0.7%), the 2-hour and 20-hour samples showed 10% and 17% oxygen, respectively. In the absence of intercalation, this suggests a gradual etching of the multilayer lattice assemblies from outside in. As the carbon's mass decreases, its percentage of the overall mass of carbon and oxygen also decreases. FIG. 5A also shows the 0/C ratio for all 3 samples. The 0/C ratio for sample A3 80xBT-20 hrs is 0.21, a level that might be typical of reduced GO.

XPS concentrations (atomic %) of various oxygen-containing species in the 2 and 20 hour samples (A3 80xBT-2 hr and A3 80xBT-20 hr, respectively) are shown in FIG. 9B. The data in FIG. 9B demonstrate that the oxidation for both 2 and 20 hour samples occurs not only at the lattice edges, but also within the basal planes. This is because the XPS results for both 2 and 20 hour samples show substantial amounts of epoxide, carbonyl, and hydroxyl moieties, which indicate basal plane oxidation. Obtaining a significant presence of these functional groups in the basal plane of hexagonally tiled lattices would generally require stronger oxidizing agents.

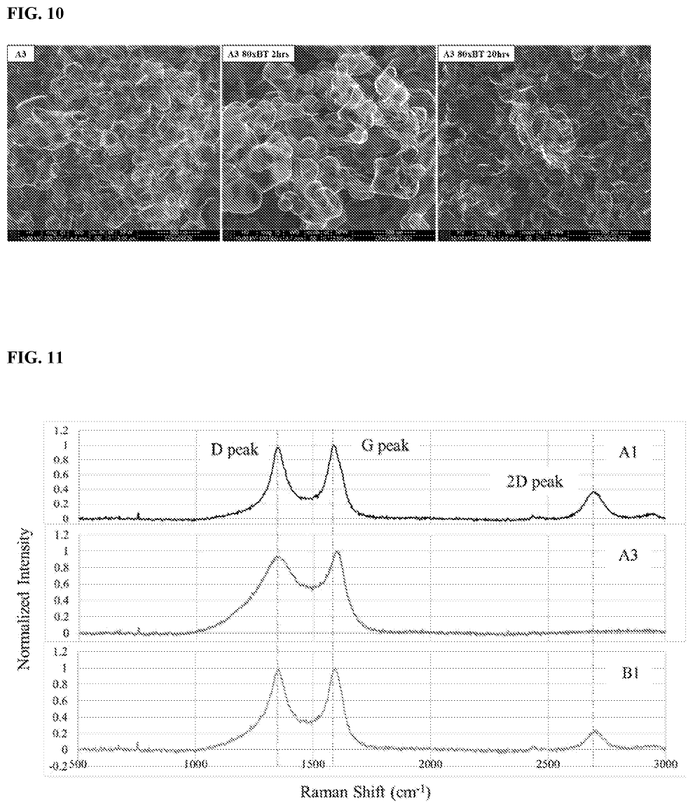

Introduction of non-hexagonal rings into the lattice creates a non-planar surface that may not be conducive to well-ordered stacking. Puckered regions may increase the spacing between lattices over a range of hundreds of rings. XRD analysis of the Sample A1 showed a d-spacing of 3.45 Å, which is typical of planar, turbostratically stacked graphene lattices. Compared to this, the d-spacings of Samples A3 and A4 were larger at 3.57 Å and 3.53 Å, respectively. Whereas oxygen intercalation typically increases the d-spacing between lattices, the d-spacings for Samples A3 and A4 after oxidation were not significantly higher, further suggesting a lack of intercalation. This is further evidenced by SEM analysis (FIG. 10) of these samples, which confirms that the multilayer lattice assemblies have retained their original, templated shapes—a desirable attribute for porous carbons produced on templates and one that might have been degraded if the spacing between the layers in the assemblies had been expanded like oxidized graphitic structures.

A few other clear benefits pertain to this process. First, there is no requirement for base-washing or chemical reduction steps (although they could be incorporated). Unlike Hummer's Method, tunable oxidation is facile, merely requiring that the conditions of the autocatalyzed ring formation be set such that a desired defect concentration is obtained and a corresponding amount of oxygen groups bonded to the carbon. Moreover, since the byproduct of the reaction is dissolved sodium chloride (NaCl), and since the reaction may be allowed to continue until all of the sodium hypochlorite is consumed and converted, the functionalization can be performed in a way that allows for easy disposal of a non-toxic, neutral-pH brine. If a different brine were preferred—for example, a lithium chloride brine—the hypochlorite species associated with the desired cation might be utilized.

The results of experiment A demonstrate that lattice nuclei can be nucleated in a reactor, and that autocatalyzed growth can be utilized to grow new lattice regions with controllable concentrations of non-hexagonal rings. One simple way to induce the formation of non-hexagonal rings is to adjust the average temperature associated with the formation of the engineered carbon lattice. Different hydrocarbon feedstocks can be utilized with different lattice growth kinetics. In Experiment A, templates were utilized, but other embodiments of the process could exclude the use of templates. The functionalized carbons produced in Experiment A comprise both individual functionalized lattices and multilayer assemblies of functionalized lattices. The controllable levels of basal plane functionality obtained with a mild oxidation process demonstrate the increased reactivity of the defective lattices formed. The lack of intercalation shows that side-selective functionalization can be obtained by exposing only one side of a lattice region, and the increased O:C ratio as a function of time demonstrates that the oxidation process utilized comprised a progressive oxidative etching. This was corroborated by the amber color of the filtrate after filtering the oxidized carbon. Amber filtrates are indicative of OD generated by lattice etching.

### Experiment B

Experiment B demonstrates synthesis of templated multilayer lattice assemblies with distinct functional strata. In Part 1 of Experiment B, a multilayer structure comprising an inner, unfunctionalized stratum and two functionalized surface strata is demonstrated. The distinct lattice characteristics of each stratum were obtained by using a three-stage template-directed CVD process. In Part 2 of Experiment B, a multilayer structure comprising one unfunctionalized stratum and one functionalized stratum is demonstrated. The distinct lattice characteristics of each stratum were obtained by using a two-stage, template-directed CVD process. Unlike the procedure in Part 1, in which the template was extracted after completion of the three CVD stages, the procedure in Part 2 involved extraction of the template between the first and second CVD stages.

In Part 1 of Experiment B, a single sample (Sample B1) was synthesized via an MgO template-directed CVD process using furnace Scheme 1. PH-MgO templates were generated by calcining L-MgCO₃ at 1050° C. for 2 hrs. A methane/propylene/argon mixture was employed as the feed gas. 300 g of PH-MgO was loaded into a quartz tube (outer diameter 100 mm) inside the furnace's heating zone. The tube was rotated at a speed of 2.5 RPM during the temperature ramp, growth, and cool-down stages. The temperature was ramped from room temperature to 750° C. over 30 minutes and maintained at 750° C. for 30 minutes under 500 sccm Ar flow. Next, a 270 sccm C₃H₆ flow was initiated while holding Ar flow steady. This was continued for 5 minutes (CVD “Stage 1”). The C₃H₆ flow was then discontinued, and the reactor was heated to 1050° C. for 15 minutes and maintained at that temperature for an additional 30 minutes under 500 sccm Ar flow. Next, a 160 sccm CH₄ flow was initiated while holding Ar flow steady. This was continued for 60 minutes (CVD “Stage 2”). The CH₄ flow was then discontinued, and the reactor was cooled down to 750° C. over 30 minutes and maintained at that temperature for 30 minutes under 500 sccm Ar flow. Next, a 270 sccm C₃H₆ flow was initiated while holding Ar flow unchanged. This was continued for 5 minutes (CVD “Stage 3”). The C₃H₆ flow was then discontinued, and the reactor was allowed to cool to room temperature under continued Ar flow.

The MgO was extracted by acid-etching with HCl, resulting in a slurry of carbon in an aqueous MgCl₂ brine. The carbon was then filtered from the brine, rinsed with deionized water three times, and collected as an aqueous paste (B1-Aq). A solvent exchange process was then used to replace the water with acetone, resulting in an acetone/carbon paste. The paste was then evaporatively dried to form a dry carbon powder B1.

Next, the aqueous paste (“B1-Aq”) was used to evaluate the effects of a mild oxidation reaction on the carbon. Sodium hypochlorite solution (˜13 wt % NaOCl) was chosen as the oxidizing agent. For each reaction, a 0.5 wt % concentration of carbon and ˜5.3 wt % concentration of NaOCl were used as shown in Table 5.

TABLE 5
Oxidation of Carbon B1

| | |
|---|---|
| Carbon (g) | 0.25 |
| 13 wt % NaoOCl Solution (g) | 20.00 |
| Aqeuous Carbon Paste (g) | 10.96 |
| Additional H2O (g) | 18.29 |
| Carbon Loading (wt %) | 0.5% |

The reactions were run for 20 hours, after which aliquots of 24 grams (containing ˜0.12 grams of Sample carbon) were collected. The remaining solutions were allowed to react for another 20 hours (a total reaction time of 40 hours). The solutions sampled at the 20-hour and 40-hour marks were filtered, followed by washing the carbon retentate with DI water and re-suspending in a 0.2M HCl solution. The acidic solution was stirred for 10 minutes, then filtered and washed with DI water to obtain an aqueous paste of oxidized carbon. A solvent exchange process was then used to replace the water with acetone, resulting in an acetone paste. The paste was then evaporatively dried at 60° to form an oxidized carbon powder. Carbons oxidized using this protocol were labelled “B1 80xBT-20 hr” or “B1 80xBT-40 hr,” based on whether they were run for 20 hours or 40 hours.

In Part 2 of Experiment B, to demonstrate a two stage CVD process, sample B2 was synthesized via an MgO template-directed CVD process in the first stage using furnace Scheme 1 followed by removal of the template. Sample B2 was used in the second stage of an autocatalyzed lattice growth CVD process using furnace Scheme 3 to synthesize sample B3. All process gases were sourced from Praxair.

For Sample B2, a mixture of CH₄ and Ar was employed as the feed gas. The quartz tube was loaded with 500 g of Elastomag 170 (EL-170) grade MgO. It was then closed and rotated at 10 RPM. After initiating a 500 sccm Ar flow, the furnace temperature was ramped from room temperature to 1050° C. over 50 minutes. It was then maintained at 1050° C. for 30 minutes. Ar gas flow was sustained during both the temperature ramp and steady state. Next, a 1200 sccm CH₄ flow was initiated while holding the Ar flow unchanged. This was continued for 45 minutes. The CH₄ flow was then discontinued, and the furnace was allowed to cool to room temperature under continued Ar flow. The MgO was extracted by acid-etching with hydrochloric acid (HCl) under excess acid conditions, resulting in a slurry of carbon in an aqueous magnesium chloride (MgCl₂) brine. The carbon was then filtered from the brine, rinsed three times with deionized water, and collected as an aqueous paste (B2-Aq). A solvent exchange process was then used to replace the water with acetone, resulting in an acetone paste. The paste was then evaporatively dried to form a dry carbon powder B2.

For Sample B3, a mixture of C₃H₆ and Ar was employed as the feed gas and a quartz tube was used for the run. After initiating a 4700 sccm Ar flow, the furnace was heated from room temperature to a temperature setting of 750° C. over 20 minutes, then it was maintained at 750° C. for 30 minutes, all while sustaining the Ar flow. An alumina boat containing 0.302 g of B2 dry powder was then placed in the cold zone of the tube for 10 minutes to remove air under the high Argon flow. The boat was then slid into the heat zone and held there for 5 minutes to allow temperature equilibration. Next, a 750 sccm C₃H₆ flow was initiated while holding the Ar flow unchanged. This was continued for 23 minutes. The C₃H₆ flow was then discontinued, and the boat was left in the heat zone for 5 minutes. The boat was then slid into the cold zone and held there for 10 minutes to allow temperature to drop under the high flow Argon blanket. The sample B3 was weighed after it had cooled to room temperature.

Next, samples B2 and B3 were oxidized using a sodium hypochlorite solution (˜13 wt % NaOCl). For each reaction, a 0.6 wt % concentration of carbon and ˜3.1 wt % concentration of NaOCl were used, as shown below in Table 6.

TABLE 6
Oxidation of Carbons B2 and B3

| | B2-Ox | B3-Ox |
|---|---|---|
| Carbon (g) | 0.1 | 0.1 |
| 13 wt % NaoOCl Solution (g) | 4.00 | 4.00 |
| Additional H2O (g) | 12.67 | 12.67 |
| Carbon Loading (wt %) | 0.60% | 0.60% |

The reactions were run for 30 minutes. After this, the contents was filtered to yield carbon retentate which was washed with DI water and re-suspended in a 0.2M HCl solution. The acidic solution was stirred for 10 minutes. Subsequently the acidic solution was filtered and washed with DI water to obtain an aqueous paste of oxidized carbon. A solvent exchange process was then used to replace the water with acetone, resulting in an acetone paste. The paste was evaporatively dried at 60° to form an oxidized carbon powder. Carbons oxidized using this protocol were labeled B2-Ox and B3-Ox

### Experiment B—Materials Characterization & Analysis

The carbon yield (after CVD rendered the MgO powder dark grey by depositing carbon) was measured via the ash test. At 2.25%, it was similar to the carbon samples from Experiment A. Table 7 below summarizes the process parameters and yield:

TABLE 7
Yield and Parametric Data for Sample B1

| Substrate | L-MgCO3 1050 C.-2 hrs |
|---|---|
| Substrate mass (g) | 300 |
| Rotary Bed | Yes |
| No. of Growth Steps | 3 |
| Growth Temperature (° C.) | 750∥1050∥750 |
| Growth Time (mins) | 5∥60∥5 |
| Gas Type-Flow rate (sccm) | 30∥10∥30 |
| Clinker Ash or Yield (%) | 2.25% |

Raman spectroscopy was used to analyze the carbon's defectiveness prior to template extraction. The spectra for Sample B1 is shown in FIG. 11, and the spectral peak ratios are shown below in Table 8:

TABLE 8
Raman Peak Ratios for Samples A1, A3 and B1

| | A1 | | A3 | | B1 | |
|---|---|---|---|---|---|---|
| | | Std. | | Std. | | Std. |
| | Average | Dev. | Average | Dev. | Average | Dev. |
| I_{D}/I_{G} | 0.970 | 6.85% | 0.960 | 3.47% | 0.982 | 5.52% |
| I_{2D}/I_{G} | 0.416 | 12.46% | 0.111 | 20.51% | 0.282 | 29.53% |
| I_{T}/I_{G} | 0.170 | 23.66% | 0.432 | 7.67% | 0.220 | 28.56% |

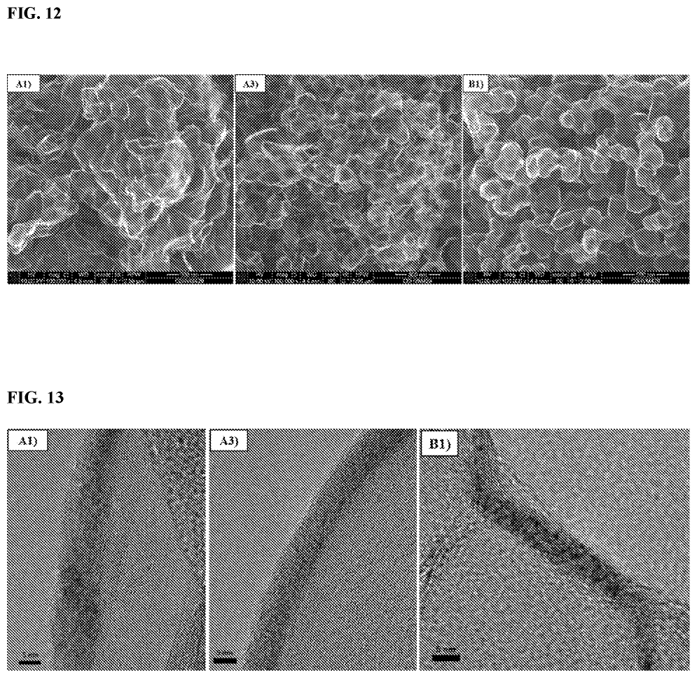

The Raman spectra for Sample B1 indicated an intermediate level of both two-dimensional ordering (i.e. an I_{2D}/I_{G} between A1's and A3's) and of defects (i.e. an I_{T}/I_{G} between A1's and A3's). This hybrid Raman result indicates the presence of three strata, two of which resembles A1's and one of which resembles A3's. The engineered carbon lattices in the stratum grown at 1050□ are, like those in Sample A1, relatively hexagonal, while the engineered carbon lattices in the stratum grown at 7500 are, like those in Sample A3, significantly more defective. SEM images of Samples A1, A3 and B1 are shown in FIG. 12 and show the hybrid nature of Sample B1 where it retains the curved shape of the template well (like A3) but also drapes across particles revealing very few broken junctions (like A1). TEM images of samples A1, A3 and B1 show the multilayer structure's cross-section or wall thickness in FIG. 13.

The concentric development a multilayer structure during template-directed growth, combined with modulations of the reactor's settings and accompanying growth conditions, enables the creation of distinct strata. The surface strata are the first and last strata synthesized on a template, corresponding to Stage 1 and Stage 3 respectively of the CVD process. The internal stratum created during the CVD Stage 2 is less defective and more chemically inert due to the presence of carbon grown at higher temperature.

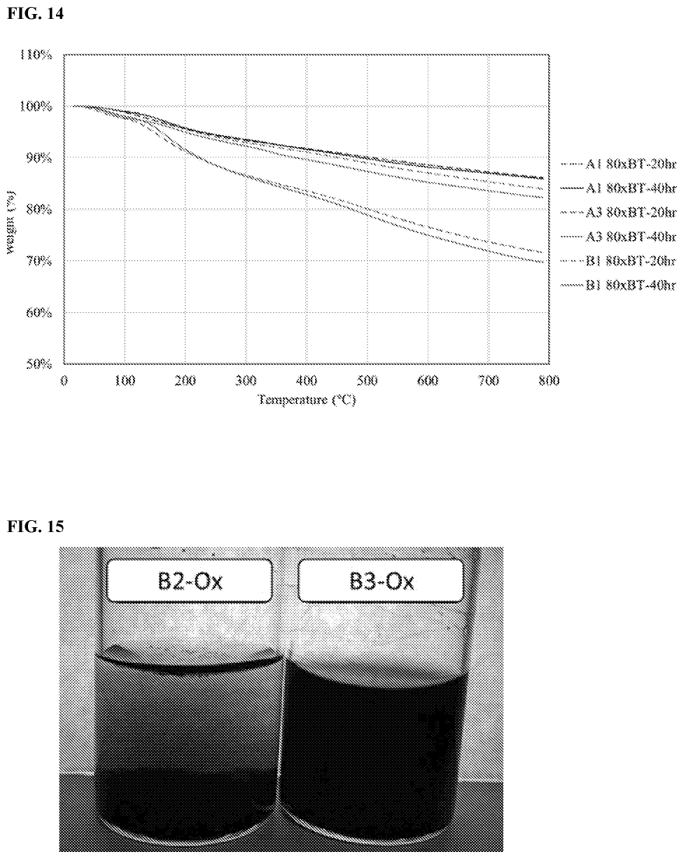

TGA of the samples oxidized with sodium hypochlorite, shown in FIG. 14, provides more information. When exposed to heat under Ar, the oxidized carbon samples exhibited a mass loss due to the removal of oxygen moieties. TGA mass loss for each of the oxidized carbons samples between the temperature of 100° C. and 750° C. is shown in Table 9.

TABLE 9
TGA mass loss for Samples A1, A3 and B1

| | A1 | A3 | B1 |
|---|---|---|---|
| % Mass remaining at | >99.5% | >99.5% | >99.5% |
| 100° C. | | | |
| % Mass remaining at | >98.0% | >98.0% | >98.0% |
| 750° C. | | | |
| % Mass loss between | <2.0% | <2.0% | <2.0% |
| 100° C.-750° C. | | | |
| | A1 80xBT-20 hr | A3 80xBT-20 hr | B1 80xBT-20 hr |
| % Mass remaining at | 99% | 98% | 99% |
| 100° C. | | | |
| % Mass remaining at | 87% | 72% | 85% |
| 750° C. | | | |
| % Mass loss between | 12% | 25% | 15% |
| 100° C.-750° C. | | | |
| | A1 80xBT-40 hr | A3 80xBT-40 hr | B1 80xBT-40 hr |
| % Mass remaining at | 99% | 98% | 98% |
| 100° C. | | | |
| % Mass remaining at | 86% | 71% | 83% |
| 750° C. | | | |
| % Mass loss between | 13% | 27% | 15% |
| 100° C.-750° C. | | | |

Comparing the Raman and mass loss data between Samples B1, A1, and A3 provides further insight into the structure of Sample B1. For Sample A1, the Raman spectra indicated a relatively high degree of order, corresponding to a high degree of hexagonal tiling. For Sample A3, the Raman spectra showed considerably more defects. Sample A1 had a yield of 1.7% (Table 2), and the exact growth conditions were used to generate the inner core of Sample B1, which had a yield of 2.25% (Table 7). Therefore Sample B1 consists predominantly of Sample A1-type lattices, with relatively thin surface strata of Sample A3-type lattices. The TGA confirms that the mass loss (which is a proxy for oxidation level) of Sample B1 (15%) is more indicative of a Sample A1 (12%) type lattice structure with slightly higher oxidation likely from the presence of the defective surface strata (see Table 9).

The conditions of growth for B2 produced a relatively high degree of hexagonal tiling based on observed Raman spectra that showed a 2D peak. The conditions chosen for B3 were such that a thin stratum of defective carbon (˜14% of the overall mass) would be grown over B2, but also produce a dramatic change in hydrophilicity. Sample B3 is therefore a stratified multilayer structure consisting of a reactive “skin” formed over an inert stratum. This structure enables a stratum-selective functionalization of the surface in order to disperse hydrophobic carbon nanoparticles more effectively.

Table 10 shown below summarizes the mass increase of B3 based on the parametric combination used for the growth of B2.

TABLE 10
Yield and Parametric Data for Sample B3

| | |
|---|---|
| Substrate | Carbon B2 |
| Rotary Bed | No |
| Original mass (g) | 0.3021 |
| Final Mass (g) | 0.3455 |
| Mass Increase (g) | 0.0434 |
| % Mass Increase (%) | 14.37% |
| Growth Temperature (° C.) | 750 |
| Growth Time (mins) | 23 |
| Gas Type (Flow rate) | C₃H₆-750 |

Unlike Experiment A, wherein oxidation was shown to be progressively etching the multilayer structure and generating OD over a long period, Experiment B employed a much shorter oxidation period, intending to limit etching. Reducing the oxidation time to about 30 minutes yielded oxidation of the carbon surfaces, increased the carbon's hydrophilic character (as shown in FIG. 15), and resulted in no observable OD generation.

### Experiment C

Experiment C demonstrates the role that controllable chemical reactivity plays in attaching other molecules to nanocarbons. It builds on the results from Experiment A and B, which demonstrated side-selective and stratum-selective functionalizations of engineered lattices and multilayer lattice assemblies. It also demonstrates an embodiment of the lattice-engineering process wherein a lattice nucleus is conveyed through a reaction zone concurrently with the growth of new lattice regions.

In Experiment C, one carbon sample (C0) was synthesized via an MgO template-directed CVD process using the Scheme 2 furnace arrangement in two steps (described below). The MgO templates were produced by calcining Elastomag-170 (EL-170) at a temperature of 1050° C. for 1 hour, resulting in a powder of ovoid particles (Ov-MgO).

In Step 1, the quartz tube with a 60 mm outer diameter and furnace were both tilted to an incline of 0.6 degrees. The tube was rotated at approximately 6 RPM. A mixture of C₃H₆ and Ar was employed as the feed gas. The hopper was loaded with 2718 g of Ov-MgO, then it was sealed and maintained under a slight positive pressure using an Argon flow of 4720 sccm to prevent any air entering the system.

After initiating a second 4720 sccm Ar flow in the quartz tube, the furnace was heated from room temperature to two temperature settings of 850° C. in Zone 1 (upstream) and 750° C. in Zone 2 (downstream) over 30 minutes. This reactor configuration, once established and maintained throughout the course of the CVD process, creates multiple gradients through which the carbon lattice nucleus and new lattice regions are conveyed concurrently with autocatalyzed carbon growth. The first gradient was the ramp-up from the temperature at which in-situ lattice nucleation occurs to approximately 850° C. The second thermal gradient through which the growing carbon lattice would be moved was the cool-down from the temperature of Zone 1 to the temperature of Zone 2 (i.e. 850° C. to 750° C.). The third thermal gradient through which the carbon lattices would be moved was the cool-down from the temperature of Zone 2 to the temperature at which autocatalyzed lattice growth terminated. In addition, utilizing the CVD furnace according to the Scheme 2 also creates other parametric gradients, such as the partial pressures of the carbonaceous feed gas and various hydrocarbon and hydrogen decomposition products resulting from deposition.

Once the furnace zones reached the set temperatures, the system was maintained at those temperatures for 30 minutes under Ar flow. The MgO powder feeding system was turned on with the auger screw set to about 7% which corresponds to a gravimetric feed rate of ˜8 g/min of the MgO powder. The depth was set to the low setting to allow a shallow bed to move through the feeding tube while the paddle agitation was set at 10% to ensure the powder is not packed or densified. The powder had a residence time of approximately 14 minutes in the heated zone of the furnace. It took about 20 minutes (from the start of initial material feeding) to achieve a steady-state bed (i.e. where mass flowing into the heat zone and out of the heat zone at any instant was approximately the same). After the steady-state bed was achieved a 250 sccm C₃H₆ flow was initiated, while holding Ar flow unchanged. Powder exiting the tube during the first 25 minutes (from the start of hydrocarbon gas flow) was discarded. Collection began at the 25 minute mark (from the start of hydrocarbon gas flow). The reaction took about 4 hours 45 minutes to complete and resulted 2203 g of product.

In Step 2, the quartz tube (60 mm outer diameter) and furnace were both tilted to an incline of 0.6 degrees. The tube was rotated at approximately 6 RPM again. A mixture of C₃H₆ and Ar was employed as the feed gas. The hopper was loaded with the 2181 g of the powder collected from Step 1, then it was sealed and maintained under a slight positive pressure using an Argon flow of 4720 sccm to prevent air from entering the system. After initiating a second 4720 sccm Ar flow in the quartz tube, the furnace was heated from room temperature to a temperature setting of 750° C. (zone 1—upstream) and 750° C. (zone 2—downstream) over 30 minutes. Therefore, the furnace contained two thermal gradients (the ramp up to 750° C. and the ramp down from 750° C.).

Once the furnace zones reached the set temperatures, the system was maintained for 30 minutes to allow for equilibration, all while sustaining the Ar flow. The powder feeding system was turned on with the auger screw set to about 7% which corresponds to a gravimetric feed rate of ˜8 g/min of the MgO powder. The depth was set to the low setting to allow a shallow bed to move through the feeding tube while the paddle agitation was set at 10% to ensure the powder is not packed or densified. The powder had a residence time of 15 minutes in the heat zone. It took about 20 minutes (from the start of initial material feeding) to achieve a steady-state bed (i.e. where mass flowing into the heat zone and out of the heat zone at any instant was approximately the same). After the steady-state bed was achieved a 500 scan C₃H₆ flow was initiated, while holding Ar flow unchanged. Powder exiting the tube during the first 25 minutes (from the start of hydrocarbon gas flow) was discarded. Collection began at the 25 minute mark (from the start of hydrocarbon gas flow). The reaction took about 4 hours 50 minutes to complete and resulted 1925 g of product.

Due to the formation of heavier molecular weight hydrocarbon condensates in the downstream portion of the quartz tube, the powder from the second CVD step was heated at 300° C. overnight to remove volatiles deposited during the synthesis. The MgO was then extracted by acid-etching with HCl under excess acid conditions, resulting in a slurry of carbon in an aqueous MgCl₂ brine. The carbon was then filtered from the brine, rinsed three times with deionized water, and collected as an aqueous paste (C0-Aq) with a carbon content of 45.10 g. A part of this aqueous paste (50 mg of Carbon) was used to produce an isopropyl alcohol paste (C0-IPA) using a solvent exchange process.

A part of the remaining aqueous paste was converted to the oxide version (C0-Ox) to evaluate its effect in an epoxy formulation. Sodium hypochlorite solution (˜13 wt % NaOCl) was chosen as the oxidizing agent. A 0.74 wt % concentration of carbon and ˜5.5 wt % concentration of NaOCl was used as shown below in Table 11.

TABLE 11
Oxidation of Carbon CO

| | |
|---|---|
| Carbon (g) | 12.95 |
| 13 wt % NaoOCl Solution (g) | 518 |
| Carbon Paste (g) | 493 |
| Additional H2O (g) | 729 |
| Carbon Loading (wt %) | 0.74% |

The reaction was run for 120 minutes and at completion the solution was filtered. The carbon retentate was washed with DI water and re-suspended in a 0.2M HCl solution. The acidic solution was stirred for 10 minutes, then was filtered and washed with DI water in order to obtain an aqueous paste of oxidized carbon (C0-Ox-Aq).

As shown in Table 12, C0-Ox was reacted with octyltriethoxysilane. A part of the C0-Ox-Aq batch was mixed with DI water and sonicated using a Branson 8510DTH bath sonicator to produce suspension of C0-Ox in water. Octyltriethoxysilane (OTES) was dissolved in IPA and added to the C0-Ox aqueous solution and the mixture was stirred on a magnetic stir-plate at room temperature for 1 hour. This was followed by filtration and washing with IPA to remove excess OTES. The residue after filtration was heated at 110° C. for 2 hours to complete the reaction. After the heating step, the residue was subsequently rinsed with IPA thoroughly a second time to wash away any unreacted OTES from the carbon surface and the product which was dried at 110 C for 2 hours was named C0-Ox-OTES. These carbons namely C0, C0-Ox and C0-Ox-OTES were characterized using their wetting behavior in water and using the TGA.

TABLE 12
Silane Functionalization of C0-Ox

| | |
|---|---|
| OTES (g) | 0.45 |
| Carbon (g) | 0.045 |
| Carbon Paste (g) | 1.44 |
| Mass of H₂O used for Carbon (g) | 73 |
| Mass of IPA used for OTES (g) | 73 |

### Experiment C—Materials Characterization & Analysis

TGA analysis of samples C0 and C0-Ox were performed to confirm oxygen functionalization on sample C0-Ox. When exposed to a heating rate of 20 C/min from room temperature to 750° C. under Argon flow as seen in Table 13, the mass loss numbers between 100-750° C. for C0-Ox was about 5% as opposed to a negligible mass loss for sample C0.

TABLE 13
TGA mass loss for C0, C0-Ox and C0-Ox-OTES

| | C0 | C0-Ox | C0-Ox-OTES |
|---|---|---|---|
| % Mass remaining at 100° C. | >99.5% | 99% | 98% |
| % Mass remaining at 750° C. | >99.0% | 94% | 90% |
| % Mass loss between 100° C.-750° C. | <1% | 5% | 9% |

As detailed in the XPS results in Expt. A, two of the basal plane functional groups after oxidation comprise hydroxyl and carboxyl groups, both of which have an —OH moiety. A vast array of other useful functional groups such as glycidyl (epoxy), amine, vinyl and aliphatic chains etc. can be added to these groups via silane coupling reaction. Addition of other functional groups would be useful in incorporation of these oxidized carbon structures into various polymer systems in a manner that would compatibilize them with the polymer matrix.

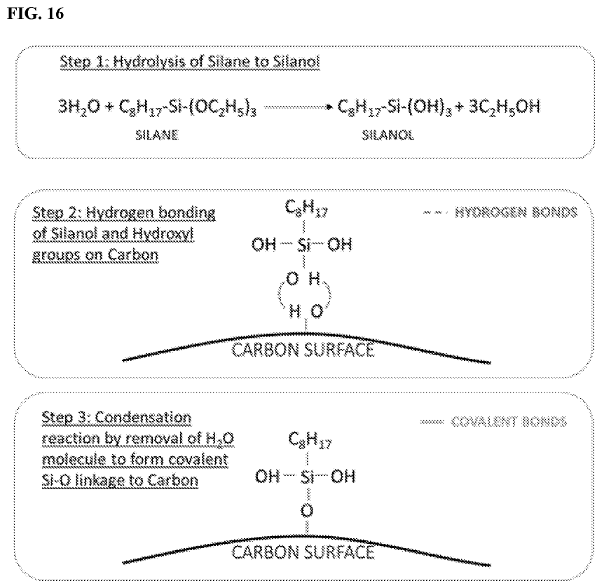

In this experiment, octyltriethoxysilane (OTES) was chosen as the silane. OTES has an aliphatic chain attached to the silicon atom. The schematic for silane functionalization of the hydroxyl groups on the carbon surface is shown in FIG. 16. Step 1 is the hydrolysis of the silane to ‘activate’ it to form its silanol and this process occurs in the presence of water. Step 2 involves formation of hydrogen bonds between the silanol and the hydroxyl groups on the C0-Ox surface and this occurs under stirring at room temperature. Step 3 involves converting the hydrogen bonds to permanent covalent linkages by a condensation reaction where a H₂O molecule is removed and this occurs under heat typically around 110° C. for 1 hour.

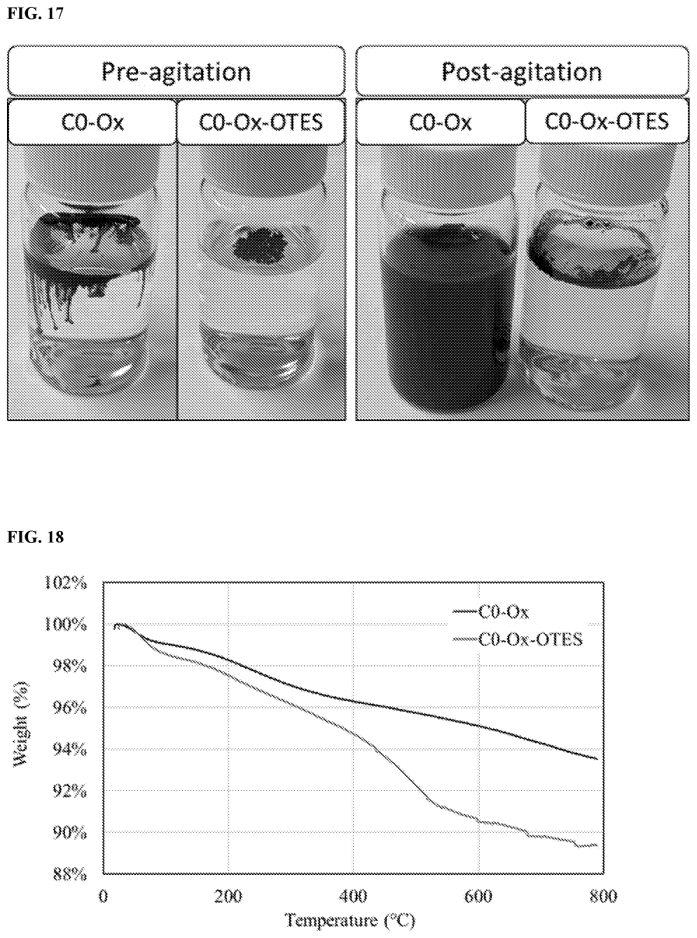

The functionalization with silane was evident as the wetting behavior of sample C0-Ox changed dramatically after silane treatment, making the hydrophilic oxidized carbon surface hydrophobic. As seen in FIG. 17, the C0-Ox sample is hydrophilic and instantly disperses in water with minimal agitation while with agitation it forms a stable suspension. After silane treatment however C0-Ox-OTES is hydrophobic and does not disperse even with agitation. This conversion from hydrophilic to hydrophobic wetting is due to the long, hydrophobic aliphatic chains comprising part of the silane molecule.

The TGA curves in FIG. 18 of the samples C0-Ox, C0-Ox-OTES performed in Argon show that the hydrophilic to hydrophobic transition is not removal of oxygen functionality (i.e conversion to reduced graphene oxide). The higher mass loss is higher for sample C0-Ox-OTES indicates a new chemistry on the surface that has converted the hydrophilic C0-Ox into the hydrophobic C0-Ox-OTES. The TGA profile used was a 20° C./min ramp from room temperature to 800° C. under a 100 mL/min flow of air. Also, in FIG. 18 there is a more pronounced mass loss event with an onset at 425° C. which could be removal of the long chain aliphatic groups attached to the silicon.

Experiment C demonstrates that an initial oxidative functionalization of the engineered carbon lattices and assemblies can serve as a platform for creating a variety of functionalities. To the extent that the initial functionalization procedure is able to functionalize the carbon feedstock selectively, further functionalizations building on the first may also be applied selectively. Additionally, Experiment C demonstrates a CVD process in which the lattice nucleus and new lattice regions are conveyed through one or more parametric gradients within the reactor. This is distinguished herein from CVD processes such as those utilized in Experiments A and B, wherein each CVD stage is performed at constant conditions. One capability enabled by a parametric gradient is the ability to obtain continuous gradations of lattice features, as well as the functionalities pertaining to those features after functionalization. Parametric gradients may allow more finely modulated, dynamic CVD procedures than could practically be engineered via multiple CVD stages. Additionally, conveying the growing lattice through a parametric gradient concurrently with growth allows for a wide range of lattice properties to be designed into the lattice without the necessity of sudden, step-wise reengineerings of the lattice tiling (e.g. growing completely amorphous new lattice regions from a hexagonal lattice nucleus). Such sudden changes in the lattice structure may not be ideal for certain properties, such as mechanical stress transfer and strength.

### Experiment D

Experiment D was performed to demonstrate generally that engineered carbon lattices can be synthesized on carbon lattice nuclei without the need for a non-carbon catalyst, template, or support. In addition, Experiment D demonstrates specifically that carbon black lattice nuclei can be utilized as inexpensive CVD feedstocks, and that the new lattice regions grown autocatalytically on a variety of carbon feedstocks can also be tuned with respect to reactivity and functionality. Lastly, Experiment D demonstrates a process embodiment in which pre-nucleated carbon lattice nuclei are introduced into the reactor, in contrast to process embodiments in which both nucleation and CVD growth occur in-situ.

In Experiment D, two carbon samples (D1 and D2) were synthesized via autocatalyzed lattice growth using a typical conductive grade carbon black (D0) as the substrate. All process gases were sourced from Praxair. The conductive grade carbon black VULCAN XC72R was sourced from Cabot. In Experiment D, D1, and D2 were synthesized via autocatalyzed lattice growth using the Scheme 3 furnace arrangement.

For Sample D1, a mixture of C₃H₆ and Ar was employed as the feed gas, and a quartz tube was used for the run. After initiating a 4700 sccm Ar flow, the furnace was heated from room temperature to a temperature setting of 750° C. over 20 minutes, then it was maintained at 750° C. for 30 minutes, all while sustaining the Ar flow. An alumina boat containing 1 g of carbon black (D0) was then placed in the cold zone of the tube for 10 minutes to allow removal of air under the high Argon flow. The boat was then slid into the heat zone and remained there for 5 minutes to allow temperature equilibration. Next, a 750 sccm C₃H₆ flow was initiated while holding the Ar flow unchanged. This was continued for 60 minutes. The C₃H₆ flow was then discontinued and the boat was left in the heat zone for 5 minutes. The boat was then slid into the cold zone and held there for 10 minutes to allow temperature to drop under the high flow Argon blanket. The sample D1 was weighed after it had cooled to room temperature.

For Sample D1, a mixture of CH₄ and Ar was employed as the feed gas, and a quartz tube was used for the run. After initiating a 4700 sccm Ar flow, the furnace was heated from room temperature to a temperature setting of 1050° C. over 50 minutes, then maintained at 1050° C. for 30 minutes, all while sustaining the Ar flow. An alumina boat containing 1 g of carbon black (D0) was then placed in the cold zone of the tube for 10 minutes to allow removal of air under the high Argon flow. The boat was slid into the heat zone where it remained for 5 minutes to allow temperature equilibration. Next, a 130 sccm CH₄ flow was initiated while holding the Ar flow unchanged. This was continued for 30 minutes. The CH₄ flow was then discontinued, and the boat was left in the heat zone for 5 minutes. The boat was then slid into the cold zone and held there for 10 minutes to allow temperature to drop under the high flow Argon. The sample D1 was weighed after it had cooled to room temperature.

Table 14 summarizes the mass increase resulting from performing the CVD procedures from Experiment D on the carbon black seeds. Table 14 also summarizes the relevant process parameters:

TABLE 14
Yield and Parametric Data for Samples D1 and D2

| | D1 | D2 |
|---|---|---|
| Substrate | Carbon Black-D0 | Carbon Black-D0 |
| Rotary Bed | No | No |
| Original mass (g) | 1.002 | 1.0066 |
| Final Mass (g) | 2.1707 | 1.3412 |
| Mass Increase (g) | 1.1687 | 0.3346 |
| % Mass Increase (%) | 116.64% | 33.24% |
| Growth Temperature (° C.) | 750 | 1050 |
| Growth Time (mins) | 60 | 30 |
| Gas Type (Flow rate) | C₃H₆-750 | CH₄-133 |

Next, samples D1 and D2 were oxidized using a mild oxidant of sodium hypochlorite solution (˜13 wt % NaOCl). For each reaction, a 0.4 wt % concentration of carbon and ˜4.2 wt % concentration of NaOCl were used, as shown below in Table 15.

TABLE 15
Oxidation of Carbons D1 and D2

| | D1-Ox | D2-Ox |
|---|---|---|
| Carbon (g) | 0.15 | 0.15 |
| 13 wt % NaoOCl Solution (g) | 12.00 | 12.00 |
| Additional H2O (g) | 25.50 | 25.50 |
| Carbon Loading (wt %) | 0.40% | 0.40% |

The reactions were run for a total of 20 hours and then filtered, followed by washing the carbon retentate with DI water and re-suspending in a 0.2M HCl solution. The acidic solution was allowed to stir for 10 minutes, then filtered and washed with DI water to obtain an aqueous paste of oxidized carbon. A solvent exchange process was then used to replace the water with acetone, resulting in an acetone paste. The paste was then evaporatively dried at 60□ to form an oxidized carbon powder. Carbons oxidized using this protocol were labelled D1-Ox and D2-Ox.

### Experiment D—Materials Characterization and Analysis

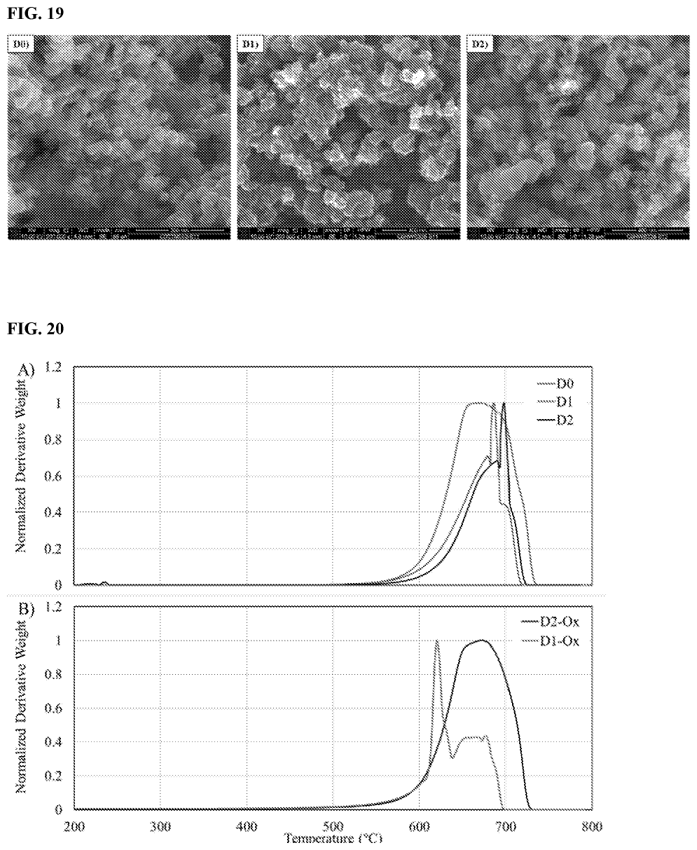

SEM images of samples D0, D1, and D2 are shown in FIG. 19. The appearance of the particles in Samples D2 and D0 are very similar, indicating conformal carbon growth. The particles in D1, however, appear to possess a rough carbon surface, likely due to tangential or non-conformal growth. Such growth is indicative of a higher degree of hexagonal tiling, which creates planar lattice regions with less freedom to conform to complex surfaces.

TGA curves of Samples D0, D1, and D2 (FIG. 20A) show the differing thermal nature of the new lattice regions grown on D0. For sample D1 the onset of mass loss associated with carbon burning starts at a lower temperature than D0. For sample D2, the onset point is higher. This is consistent with D1 having a non-hexagonal lattice, while D2's more hexagonal lattice arrangement possesses higher thermal stability. The post-oxidation TGA curves of D1-Ox and D2-Ox are shown in FIG. 20B. Here, again, different behaviors between the samples can be observed, with complex thermal events occurring. The sharp peak seen for D1-Ox is a feature of highly oxidized carbon burning off rapidly, while the more gradual burn-off for D2-Ox is a feature of less oxidized carbon.

### Experiment E

Experiment E demonstrates the ability to obtain group-selective functionalizations and to obtain oxidations with a variety of oxidizing agents, as well as oxidations involving combinations of oxidizing agents and acids. Experiment E also demonstrates the ability to attach functional groups between lattice-layers in a multilayer lattice assembly. Experiment E additionally demonstrates the ability to utilize base-washing or acidification treatments to modify the oxygen groups attached. Lastly, Experiment E demonstrates the ability to bond non-oxygen atoms such as sulfur or nitrogen to the engineered carbon lattice.

Three alternative oxidation protocols were tested on the autocatalyzed grown carbons. The first alternative oxidation protocol was a simple variation of the sodium hypochlorite treatment protocol where the treatment was carried out in the low pH (˜4) regime. The second and third protocols used solutions of sulphuric acid (H2SO4) along with either hydrogen peroxide (H2O2) and ammonium persulfate ((NH4)2S2O8) respectively to create strong oxidizing solutions for carbon oxidation.

Like the carbons used in Experiment A, three carbon samples (E0, E1 and E2) were synthesized via an MgO template-directed CVD process using the furnace Scheme 1 described above. All gases used in the synthesis were sourced from Praxair. The MgO templates were produced by calcining L-MgCO3 at a temperature of 1050° C. for 2 hours, resulting in a powder of polyhedral particles (PH-MgO).

For Sample E0, a mixture of CH4 and Ar was employed as the feed gas. The quartz tube was loaded with 300 g of PH-MgO powder. Subsequently, tube was closed and rotated at 2.5 RPM. After initiating a 500 sccm Ar flow, the furnace temperature was ramped from room temperature to 1050° C. over a 50 minute period. It was then was maintained at 1050° C. for 30 minutes. During heating Ar gas flow was sustained. Next, a 160 sccm CH4 flow was initiated while maintaining Ar flow for 60 minutes. CH4 flow was then discontinued and the furnace allowed to cool to room temperature under continuous Ar flow. The MgO was then extracted by acid-etching with HCl resulting in a slurry of carbon in an aqueous magnesium chloride (MgCl2) brine. The carbon was then filtered from the brine, rinsed three times with deionized water and collected as an aqueous paste (E0-Aq). A solvent exchange process replaced the water with acetone, resulting in an acetone paste. The acetone paste was then evaporatively dried to form a dry carbon powder E0.

For Sample E1, a mixture of C3H6 and Ar was employed as the feed gas. The quartz tube was loaded with 300 g of PH-MgO, then closed and tube rotation at 2.5 RPM was started. After initiating a 500 sccm Ar flow, the furnace was heated from room temperature to a temperature setting of 750° C. over 30 minutes, then maintained at 750° C. for 30 minutes, all under sustaining Ar flow. Next, a 270 sccm C3H6 flow was initiated while holding Ar flow unchanged. This was continued for 30 minutes. The C3H6 flow was then discontinued, and the furnace was allowed to cool to room temperature under continued Ar flow. The MgO was extracted by acid-etching with HCl under excess acid conditions, resulting in a slurry of carbon in an aqueous MgCl2 brine. The carbon was filtered from the brine, rinsed three times with deionized water, and collected as an aqueous paste (E1-Aq). A solvent exchange process was then used to replace the water with acetone, resulting in an acetone/carbon paste. The acetone paste was then evaporatively dried to form a dry carbon powder E1.

For Sample E2, a mixture of C3H6 and Ar was employed as the feed gas. The quartz tube was loaded with 300 g of PH-MgO, then closed and rotated at 2.5 RPM. After initiating a 500 sccm Ar flow, the furnace was heated from room temperature to a temperature setting of 650° C. over 30 minutes, then maintained at 650° C. for 30 minutes, all under sustained Ar flow. Next, a 270 sccm C3H6 flow was initiated while holding Ar flow unchanged. This was continued for 60 minutes. The C3H6 flow was then discontinued, and the furnace allowed to cool to room temperature under continued Ar flow. The MgO was extracted by acid-etching with HCl under excess acid conditions, resulting in a slurry of carbon in an aqueous MgCl2 brine. The carbon was then filtered from the brine, rinsed three times with deionized water, and collected as an aqueous paste (E2-Aq). A solvent exchange process was then used to replace the water with acetone, resulting in an acetone/carbon paste. The paste was then evaporatively dried to form a dry carbon powder E2.

For the first oxidation protocol, an acidic version of the sodium hypochlorite treatment was evaluated. The oxidized carbons generated using this protocol were of three forms: “acidic bleach—control,” “acidic bleach—base wash,” “acidic bleach—base wash followed by acidification.”

The ‘control’ variation was subjected to only the acidic bleach protocol as described here. Sodium hypochlorite solution (˜13 wt % NaOCl) was chosen as the oxidizing agent and 2M HCl was used to tune the pH. For the reaction, a 0.29 wt % concentration of carbon was used, as shown below in Table 16:

TABLE 16
Acidic Bleach Treatment (ABT) on E2

| | |
|---|---|
| Dry Carbon (g) | 0.05 |
| Paste E2-Aq (g) | 3.33 |
| Mass of 2M HCl (g) | 0.60 |
| 13 wt % NaOCl Solution (g) | 2.00 |
| Additional H2O (g) | 11.12 |
| Total mass of Soln. (g) | 17.05 |
| Total Vol. Of Soln. (mL) | 16.67 |
| Carbon Loading (wt %) | 0.29% |

The reaction was run for 20 hours at the end of which they were filtered, followed by washing the carbon retentate with DI water to obtain an aqueous paste of oxidized carbon. A solvent exchange process was then used to replace the water with acetone, resulting in an acetone paste. The paste was then evaporatively dried at 60° C. to form an oxidized carbon powder. Carbons oxidized using this protocol were labelled “E2 40xABT-20 hr Control”.

The ‘acidic bleach—base wash’ variation was subjected to the acidic bleach protocol followed by a base washing process as described here. Sodium hypochlorite solution (˜13 wt % NaOCl) was chosen as the oxidizing agent, 2M HCl was used to tune the pH for the reaction. 6M NaOH was used as the base washing solution. A 0.29 wt % concentration of carbon was used, as shown below in Table 17:

TABLE 17
Acidic Bleach-Base wash on E2

| | |
|---|---|
| Dry Carbon (g) | 0.05 |
| Paste E2-Aq (g) | 3.33 |
| Mass of 2M HCl (g) | 0.60 |
| 13 wt % NaOCl Solution (g) | 2.00 |
| Additional H2O (g) | 11.12 |
| Total mass of Soln. (g) | 17.05 |
| Total Vol. Of Soln. (mL) | 16.67 |
| Carbon Loading (wt %) | 0.29% |

The reaction was run for 20 hours at the end of which it was filtered, followed by washing the carbon retentate with DI water. The carbon retentate was re-suspended in a 10 g 6M NaOH solution for the base washing step. The base washing step involved magnetic stirring for 30 minutes followed by bath sonication for 30 minutes. This highly basic solution was diluted with 90 g of water and then filtered and washed with DI water to obtain an aqueous paste of oxidized carbon. A solvent exchange process was then used to replace the water with acetone, resulting in an acetone paste. The paste was then evaporatively dried at 60° C. to form an oxidized carbon powder. Carbons oxidized using this protocol were labelled “E2 40xABT-20 hr BW”.

The ‘acidic bleach—base wash followed by acidification’ variation was subjected to the acidic bleach protocol followed by a base washing process followed by an acidification step as described here. Sodium hypochlorite solution (˜13 wt % NaOCl) was chosen as the oxidizing agent, 2M HCl was used to tune the pH for the reaction. 6M NaOH was used as the base washing solution and conc. HCl was used to acidify the solution after base washing. A 0.29 wt % concentration of carbon was used, as shown below in Table 18:

TABLE 18
Acidic Bleach, Base Wash and Re-Acidification on E2

| | |
|---|---|
| Dry Carbon (g) | 0.05 |
| Paste E2-Aq (g) | 3.33 |
| Mass of 2M HCl (g) | 0.60 |
| 13 wt % NaOCl Solution (g) | 2.00 |
| Additional H2O (g) | 11.12 |
| Total mass of Soln. (g) | 17.05 |
| Total Vol. Of Soln. (mL) | 16.67 |
| Carbon Loading (wt %) | 0.29% |

The reaction was run for 20 hours at the end of which it was filtered, followed by washing the carbon retentate with DI water. The carbon retentate was re-suspended in a 10 g 6M NaOH solution for the base washing step. The base washing step involved magnetic stirring for 30 minutes followed by bath sonication for 30 minutes. This highly basic solution was diluted with 90 g of water and then filtered and washed with DI water to obtain an aqueous paste of oxidized carbon. The carbon retentate was re-suspended in 10 g of DI water and acidified using conc. HCl till the pH was less than 2 for the acidification step. The acidification step involved magnetic stirring for 30 minutes followed by bath sonication for 30 minutes. This highly acidic solution was diluted with 90 g of water and then filtered and washed with DI water to obtain an aqueous paste of oxidized carbon. A solvent exchange process was then used to replace the water with acetone, resulting in an acetone paste. The paste was then evaporatively dried at 60° C. to form an oxidized carbon powder. Carbons oxidized using this protocol were labelled “E2 40xABT-20 hr BW-RA”.

For the second alternative oxidation protocol, concentrated sulfuric acid with hydrogen peroxide (H₂O₂), more commonly referred to as a Piranha solution, was used as the oxidizing medium to oxidize carbons E0, E1 and E2.

Carbons E0, E1 and E2 were used as dry powders and subjected to Piranha Treatment as shown in Table 19 below. The Piranha solution was mix of concentrated sulfuric acid and 30 wt % Hydrogen Peroxide in a ratio of 7:1 by weight. The carbon was added to the concentrated sulfuric acid and allowed to magnetically stir for 10 mins, after which cold hydrogen peroxide was added dropwise over 5 minutes with the carbon-acid solution in an ice bath. This Piranha solution with carbon was magnetically stirred for 24 hours at room temperature.

TABLE 19
Piranha Treatment (PrT) on E0, E1 and E2

| | E0 | E1 | E2 |
|---|---|---|---|
| Dry Carbon (g) | 0.075 | 0.075 | 0.075 |
| Conc. H2SO4 (g) | 21.00 | 21.00 | 21.00 |
| 30% Hydrogen Peroxide (g) | 9.00 | 9.00 | 9.00 |
| Carbon Loading (wt %) | 0.25% | 0.25% | 0.25% |

The reaction was run for 24 hours at the end of which it was quenched by adding the carbon-piranha solution to excess water (100 mL) slowly to ensure no large exotherm. This was followed by filtration and washing the carbon retentate with DI water. A solvent exchange process was then used to replace the water with acetone, resulting in an acetone paste. The paste was then evaporatively dried at 60° C. to form an oxidized carbon powder. Carbons oxidized using this protocol were labelled “E0 PrT 24 hr”, “E1 PrT 24 hr” and “E2 PrT 24 hr”.

Samples E1 PrT 24 hr and E2 PrT 24 hr were subjected to a base washing protocol using 6M NaOH solution to generate E1 PrT 24 hr BW and E2 PrT 24 hr BW. The complete procedure for this synthesize is given below.

Carbons E1 and E2 was used as dry powders and subjected to Piranha Treatment as described by Table 19. The Piranha solution was mix of concentrated sulfuric acid and 30 wt % hydrogen peroxide in a ratio of 7:1 by weight. The carbon was added to the concentrated sulfuric acid and allowed to magnetically stir for 10 minutes, after which cold hydrogen peroxide was added dropwise over 5 minutes with the carbon-acid solution in an ice bath. This Piranha solution with carbon was magnetically stirred for 24 hrs at room temperature.

The reaction was run for 24 hours at the end of which it was quenched by adding the carbon-piranha solution to excess water (100 mL) slowly to ensure no large exotherm. This was followed by filtration and washing the carbon retentate with DI water. The carbon retentate was re-suspended in a 10 g 6M NaOH solution for the base washing' step. The base washing step involved magnetic stirring for 30 minutes followed by bath sonication for 30 minutes. This highly basic solution was diluted with 90 g of water and then filtered and washed with DI water to obtain an aqueous paste of oxidized carbon. A solvent exchange process was then used to replace the water with acetone, resulting in an acetone paste. The paste was then evaporatively dried at 60° C. to form an oxidized carbon powder. Carbons oxidized using this protocol were labelled “E1 PrT 24 hr BW” and “E2 PrT 24 hr BW”.

For the third alternative oxidation protocol, referred to here as APS Treatment, concentrated sulfuric acid with an oxidant ammonium persulfate ((NH₄)₂S₂O₈) was used as the oxidizing medium to oxidize carbons E0 and E2.

Carbons E0 and E2 were used as dry powders and subjected to APS Treatment as shown in Table 20 below. The APS solution was mix of concentrated sulfuric acid and ammonium persulfate in a ratio of 10:1 by weight. The carbon was added to the concentrated sulfuric acid and allowed to magnetically stir for 10 mins after which ammonium persulfate was slowly added over 5 mins with the carbon-acid solution in an ice bath. This APS solution with carbon was magnetically stirred for 60 hours at room temperature.

TABLE 20
APS Treatment (APS) on E0 and

| | E0 | E2 |
|---|---|---|
| Dry Carbon (g) | 0.05 | 0.05 |
| Mass of Conc. H2SO4 (g) | 18.40 | 18.40 |
| Ammonium Persulfate (g) | 1.00 | 1.00 |
| Carbon Loading (wt %) | 0.25% | 0.25% |

The reaction was run for 60 hours at the end of which it was quenched by adding the carbon-APS solution to excess water (100 mL) slowly to ensure no large exotherm. This was followed by filtration and washing the carbon retentate with DI water. A solvent exchange process was then used to replace the water with acetone, resulting in an acetone paste. The paste was then evaporatively dried at 60° C. to form an oxidized carbon powder. Carbons oxidized using this protocol were labelled “E0 APS 60 hr” and E2 APS 60 hr”.

### Experiment E—Materials Characterization & Analysis

Three alternative oxidation protocols were tested and it was demonstrated that all three were capable of oxidizing the autocatalyzed grown carbons to various degrees and with varied degrees of group-selectivity.

The first alternative oxidation protocol was a simple variation of the NaOCl treatment protocol carried out in the low pH (˜4) regime. It is known that the active oxidizing species in hypochlorite solutions is dependent on the pH regime with the amount of undissociated hypochlorous acid (HOCl) being highest at pH of ˜4 and only hypochlorite (OCl⁻) ions being present at pH greater than 7. This treatment protocol was used to compare the oxidation characteristics of bleach in the two different regimes. It was observed that in the lower pH regime oxidation protocol there was an increased degree of group-selectivity, as evident by the TGA curves. To understand the selectivity phenomenon of the groups being generated, an experiment was carried out that included sequential base washing and acidification, as these steps preferentially induce changes in some oxygen functionalities present.

TABLE 21
TGA mass loss for samples E2 40xABT variants

| | E2 40xABT- | E2 40xABT- | E2 40xABT- |
|---|---|---|---|
| | 20 hr | 20 hr | 20 hr |
| | Control | BW | BW-RA |
| % Mass remaining at 100° C. | 98.03% | 97.13% | 97.95% |
| % Mass remaining at 750° C. | 73.76% | 79.23% | 78.98% |
| % Mass loss between | 24.27% | 17.91% | 18.96% |
| 100-750° C. | | | |

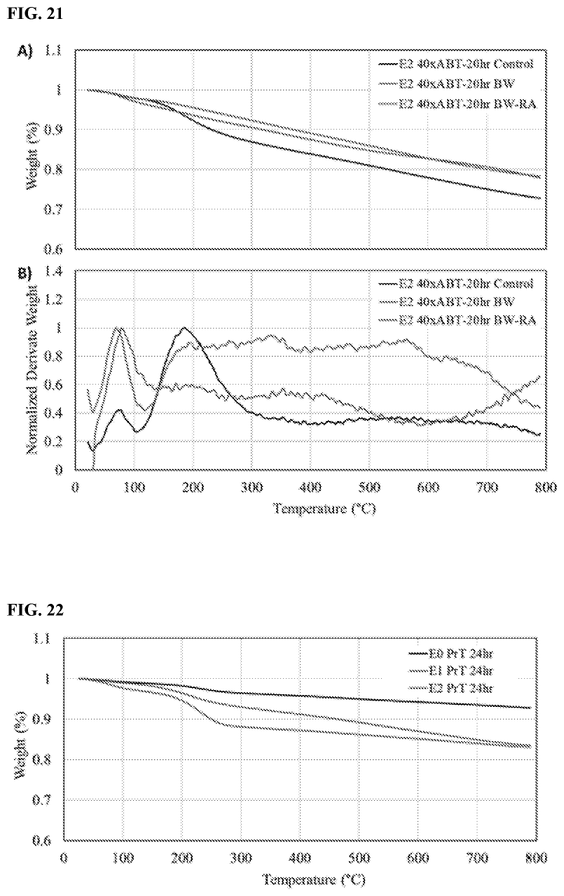

As seen in Table 21 and FIG. 21A, sample E2 40xABT-20 hr Control has the highest percentage (24.3%) of mass lost between 100° C. and 750° C., which reduces upon base-washing to about 18-19% for both samples E2 40xABT-20 hr BW and E2 40xABT-20 hr BW-RA. This drop is attributed to the removal of OD present on the carbon surface. It is important to note that even after the removal of OD, the percentage of mass lost is still ˜18%, of which 2-3% is attributable to water.

TABLE 22
XPS data showing atomic % of Carbon and Oxygen

| | E2 40xABT- | E2 40xABT- | E2 40xABT- |
|---|---|---|---|
| | 20 hr Control | 20 hr BW | 20 hr BW-RA |
| Atomic % of Carbon | 81.00% | 81.90% | 83.20% |
| Atomic % of Oxygen | 17.30% | 14.90% | 16.00% |
| Carbon/Oxygen Atomic Ratio | 4.63 | 5.50 | 5.20 |

Based on TEM images (FIG. 6) we know that the E2-type carbons have a cell wall comprised of approximately 10-15 layers. Of these layers, only the external sides of the outermost layers of the wall are oxidized. There is no oxidation between lattices within the wall, including the internal side of the outermost layers of the wall, as evidenced by the insignificant change to the interlayer d-spacing post-oxidation (ascertained via XRD analysis and TEM analysis of wall thickness measurements). Assuming a conservative model where the average number of layers in a wall is 10, and given that only 2 of the 10 layers are oxidized, all of the oxygen present in the sample is present on 2 of the 10 layers, or on one-fifth of the layers of each particle. To determine the true C:O ratio on the oxidized layers alone, the total sample C:O ratio is divided by 5, because the oxygen is present only on one-fifth of the layers. From XPS data (Table 22) for samples E2 40xABT-20 hr BW and E2 40xABT-20 hr BW-RA, it is known that the total oxygen content is between 14.9% and 16.0%, corresponding to total sample C:O ratios of 5.50 and 5.20, respectively. The true C:O ratio of the oxidized layers (with OD desorbed by the base wash) comes to 1.04-1.1, which is dramatically lower than typical base-washed graphene oxide C:O ratio values of 4-7.

Moreover, whereas the oxygen groups on graphene oxide are divided evenly between each side, in Experiment E the lattice-bound oxygen groups are all attributable to only the external side of each of the oxidized lattices. Hence, for a given C:O ratio on lattices oxidized on only one side, the functional density on the oxidized side is roughly twice the functional density on the oxidized sides of lattices that are oxidized on both sides and that possesses the same C:O ratio. This, in conjunction with the surface-specific C:O ratios for lattice-engineered oxidized carbons, suggests that much higher functional densities can be obtained on their surfaces compared to conventionally oxidized nanocarbons such as GO.

The ability to add dramatically higher amounts of oxygen onto the surfaces of carbon nanoparticles is a key advantage of the defect-induced oxidation process and will prove extremely useful in creating tailored interfaces between carbon nanoparticles and any system into which they are added.

The second and third protocols used a concentrated sulfuric acid (H₂SO₄) medium with the addition of oxidants like hydrogen peroxide —H₂O₂ (i.e. Piranha solution) and ammonium persulfate —(NH₄)₂S₂O₈ respectively. Concentrated sulfuric acid in conjunction with oxidizing agents have been shown to intercalate and bond interlayer oxygen groups to graphite, and this phenomenon was the rationale behind the second and third alternative treatment protocols.

The Raman data for samples E0, E1 and E2 are shown in Table 23. It should be noted that samples E0, E1 and E2 are the same carbon types as the ones generated in Experiment A (denoted by A1, A3 and A4, respectively).

TABLE 23
Raman Peak Ratios for Samples E0, E1 and E2

| | E0 | | E1 | | E2 | |
|---|---|---|---|---|---|---|
| | | Std. | | Std. | | Std. |
| | Average | Dev. | Average | Dev. | Average | Dev. |
| I_{D}/I_{G} | 0.970 | 6.85% | 0.960 | 3.47% | 0834 | 3.45% |
| I_{2D}/I_{G} | 0.416 | 12.46% | 0.111 | 20.51% | 0.068 | 18.09% |
| I_{T}/I_{G} | 0.170 | 23.66% | 0.432 | 7.67% | 0.395 | 3.96% |

Like A1, sample E0 is a carbon grown at high temperature, and as seen in the Raman data in Table 23 it has a relatively high I_{2D}/I_{G} ratio, which indicates a higher degree of two-dimensional ordering than the other samples, and a relatively low I_{T}/I_{G} peak ratio, indicating lower defect density. Samples E1 and E2 are carbons grown at lower temperatures, and as seen in the Raman data in Table 23, both have a low I_{2D}/I_{G} ratio (with E2 being the lowest), indicative of less two-dimensional ordering, and a high I_{T}/I_{G}, indicating a high defect density.

After Piranha treatment, samples E0, E1 and E2 had a 6%, 14.2% and 14.9% mass loss (between 100-750° C.) respectively as seen in the TGA data Table 24 and FIG. 22. Consistent with Experiment A, E1 and E2 are more susceptible to oxidation than their more hexagonal counterpart, E0, and this holds true with respect to a variety of oxidizing agents.

TABLE 24
TGA mass loss for E0, E1 and E2 after Piranha Treatment

| | E0 PrT | E1 PrT | E2 PrT |
|---|---|---|---|
| | 24 hr | 24 hr | 24 hr |
| % Mass remaining at 100° C. | 99.20% | 97.69% | 98.94% |
| % Mass remaining at 750° C. | 93.14% | 83.45% | 84.02% |
| % Mass loss between 100-750° C. | 6.06% | 14.24% | 14.93% |

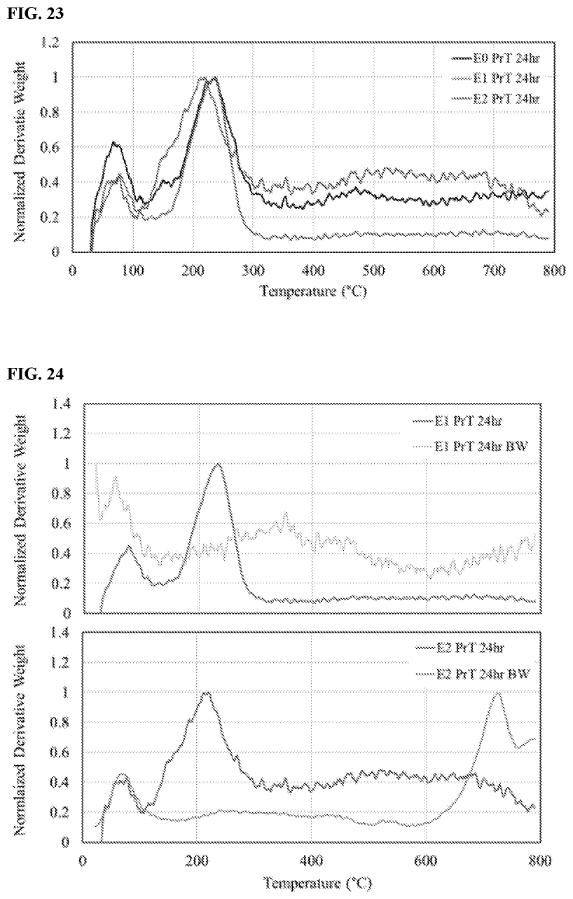

Looking closely at the oxidation between E1 and E2, there are notable differences. Although the total mass loss for E1 and E2 over the 100° C. to 750° C. range is similar (˜14-15%), closer inspection (FIG. 23 and Table 25) reveals that Sample E1 loses 9.6% in the 100° C. to 300° C. range, whereas Sample E2 loses 9.0% in the 300° C. to 750° C. range. This is indicative of group-selective functionalization, with E1 possibly being favored for more labile groups and E2 being favored for less labile groups. To explore the group-selectivity phenomenon further, base washing was used to try and understand the precise nature of the groups present on each of the oxidized carbon samples.

TABLE 25
TGA mass loss for E1 and E2 after Piranha Treatment

| | E1 PrT 24 hr | E2 PrT 24 hr |
|---|---|---|
| % Mass remaining at 100° C. | 97.69% | 98.94% |
| % Mass remaining at 300° C. | 88.11% | 93.02% |
| % Mass remaining at 750° C. | 83.45% | 84.02% |
| % Mass loss between 100-300° C. | 9.58% | 5.92% |
| % Mass loss between 300-750° C. | 4.66% | 9.00% |
| % Mass loss between 100-750° C. | 14.24% | 14.93% |

By looking closely at the mass loss in the different temperature ranges, it is possible to garner information about the specific functional groups present on the carbon surfaces. Typically, the mass loss for oxidized carbons can be broadly broken down into 4 regions viz. less than 100° C., 100-300° C., 300-600° C. and 600-750° C. based on temperature. The mass loss peak centered at 100° C. is associated with water. A second peak centered at ˜200° C. (100-300° C.) is associated with more labile oxygen groups including epoxide, carboxyl, carbonate, and some hydroxyl groups. A third broad peak centered at 450° C. (300-600° C.) is associated with less labile oxygen functionalities including carbonyl and some hydroxyl groups. The final peak centered at 720° C. (600-750° C.) is associated with groups including sodium salts of the carboxyl/carbonate groups.

Table 26 and FIG. 24 provide information on the TGA mass loss before and after the base wash.

TABLE 26
TGA mass loss for E1 and E2 after Piranha Treatment and base-wash

| | E1 | | E2 | |
|---|---|---|---|---|
| | E1 PrT 24 hr | E1 PrT 24 hr BW | E2 PrT 24 hr | E2 PrT 24 hr BW |
| % Mass remaining at 100° C. | 97.69% | 98.53% | 98.94% | 97.00% |
| % Mass remaining at 300° C. | 88.11% | 96.32% | 93.02% | 92.58% |
| % Mass remaining at 600° C. | 85.13% | 92.88% | 86.88% | 87.00% |
| % Mass remaining at 750° C. | 83.45% | 91.56% | 84.02% | 77.65% |
| % Mass loss between 100-300° C. | 9.58% | 2.21% | 5.92% | 4.42% |
| % Mass loss between 300-600° C. | 2.98% | 3.44% | 6.14% | 5.58% |
| % Mass loss between 600-750° C. | 1.68% | 1.32% | 2.86% | 9.35% |
| % Mass loss between 100-750° C. | 14.24% | 6.97% | 14.93% | 19.35% |

Most of the mass loss (9.58% of the total 14.24%) for Sample E1 PrT 24 hr occurs in the 100-300° C. range. After base washing, though, Sample E1 PrT 24 hr BW exhibits a mass loss of only 2.2% over the 100-300° C. range, which is exceeded by the mass loss of 3.4% in the 300-600° C. range. Given that the substantial reduction in total mass loss after base washing (from 14.2% to 7%), one explanation would be that E1 PrT 24 hr possessed a significant amount of OD that was removed by the base wash, and that the groups on the OD comprised much of the mass loss observed in the 100-300° C. range. However, no OD was observed in the filtrate after the base washing, indicating that OD was not the source of the mass loss.

Surprisingly, the XPS results for Sample E1 PrT 24 hr showed a 5.3% atomic concentration of nitrogen and a nearly equal 5.5% atomic concentration of sulfur. The nitrogen present is substantially all in the form of a quaternary nitrogen cations, while the sulfur is substantially all in the form of sulfate anions. At a combined nitrogen and sulfur atomic concentration of nearly 11%, and with oxygen accounting for over 22%, it is clear from the XPS that the quaternary nitrogen cations and sulfate anions comprise intercalated species.

This is surprising given the lack of nitrogen compounds in the chemicals employed. Instead, it appears that the lattices expand during intercalation of the oxidant and trap atmospheric nitrogen dissolved in the solution. The dissolved gas molecules, once introduced between the lattices, are induced to react due to extreme confinement. Confinement has been shown to increase the reactivity of certain species and the kinetics of certain reactions by many orders of magnitude, giving rise to the concept of using nanopores as “nano-reactors.” The presence of quaternary nitrogen cations and sulfate anions explains the difference in TGA mass loss, and indicates that the base washing has the effect of removing the intercalated compounds.

For sample E2 PrT 24 hr, most of the total mass loss occurs in the 100-300° C. and 300-600° C. ranges. The mass loss across these two ranges is split fairly evenly at 5.9% and 6.1%, respectively. Only 2.9% is lost in the 600-750° C. range. For sample E2 PrT 24 hr BW, however, almost half of the total mass loss occurs in the 600-750° C. range, while the mass losses in the 100-300° C. and 300-600° C. ranges decrease to 4.4% and 5.6% respectively. If there was a large amount of OD, it would be expected that the mass loss numbers would be reduced by base washing. However, the total mass loss after base washing increases significantly (from 14.93% to 19.35%). This is an indication that carboxylic acid groups on the oxidized carbon are being neutralized upon exposure to NaOH, resulting in the formation of a sodium salt.

The addition of the sodium cation to the carboxylic groups increases the total labile mass of Sample E2 PrT 24 hr BW by approximately 30% (net of any losses from OD removal) over the total labile mass of Sample E2 PrT 24 hr. The conversion of a COOH group to a salt (COONa) results in a theoretical mass increase of 56%, and if the oxygen groups on the carbon surface were 100% carboxylic acid (and there were no OD present) then the total labile mass ought to increase by approximately 56% after base washing. An empirically observed 30% increase in the labile mass therefore suggests that approximately 54% of the total labile mass was comprised of carboxylic acid—possibly more, depending on the extent to which OD-related labile mass was reduced by the base washing.

Further corroboration for this assertion is the large atomic % of sodium at ˜4.6% observed on E2 PrT 24 hr BW in XPS results, as well as the significant shift in the thermal stability of the salt formed compared to carboxylic acid. The TGA curve clearly shows a reduction in the more labile carboxyl species in favor of a stabilized species that only volatilizes in the 600-750° C. temperature range. Furthermore, the TGA curve for E2 PrT 24 hr BW-RA shows, as expected, that acidification of the base washed sample results in the restoration of the more labile species. The removal of the stabilized salt eliminates the observed shift in the mass loss toward the 600-750° C. temperature range.

Such a high level of initial carboxylic acid indicates that the carboxylic groups are located on the basal plane. While this is unusual for planar lattice feedstocks like graphene, it is preferred for convex lattice feedstocks like the exohedral surfaces of CNTs. Inspection of the TEM imagery for E2-type carbon vs. E1-type carbon reveals that the E2-type lattices are much more curved and non-planar. The wrinkled fringes are less coherent, making them difficult to track. By contrast, the E1-type lattice is much more planar. This explains the group-selective carboxylation of the E2-type lattice, whereas the E1-type lattice does not seem to have been selectively carboxylated. Namely, the E2-type lattice is comprised of convex and concave sites. When exposed to the oxidizing agent on one of its sides, the E2-type lattice is site-selectively and group-selectively carboxylated at its convex sites due to the local lattice strain (similar to exohedral nanotube surfaces). By contrast, the concave sites are expected to be less reactive and thereby contribute fewer oxygen groups. The result is a carbon that, despite its obvious differences from nanotubes (e.g. each of its lattice sides possess both concave and convex features, instead of only one or the other), resembles them insomuch as its functional groups are substantially all located on convex sites, resulting in heavy carboxylation.

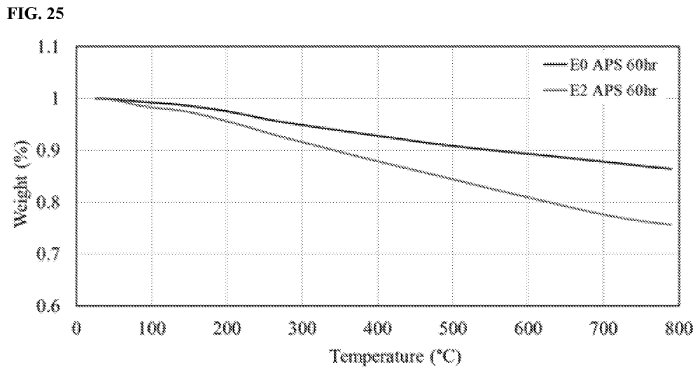

APS treatment was chosen as an additional method to demonstrate the difference in chemical oxidation potential of engineered lattices to a wide variety of oxidation protocols. After APS treatments E0 and E2 had a 12.1% and 21.9% mass loss (between 100-750° C.) respectively as seen in the TGA data in Table 27 and FIG. 25. Note that APS treatment as an oxidation protocol did not generate any observable OD.

TABLE 27
TGA mass loss for E0 and E2 after APS treatment

| | E0 APS 60 hr | E2 APS 60 hr |
|---|---|---|
| % Mass remaining at 100° C. | 99.18% | 98.23% |
| % Mass remaining at 750° C. | 87.04% | 76.32% |
| % Mass loss between 100-750° C. | 12.14% | 21.92% |

Like the other oxidative treatments in the preceding experiments, Experiment E further validates the ability to induce chemical functionalization by exposing a lattice-engineered carbon to different types of chemicals, and specifically to different types of oxidizing agents. Experiment E further demonstrates the ability to produce lattices and multilayer lattice assemblies in which lattice carbon is bonded to nitrogen or sulfur atoms. Confinement between the lattices is shown to induce certain reactions that would not be expected under normal conditions. Additionally, it is demonstrated that functional groups can be added between lattices in a multilayer structure. Experiment E also shows that for one-sided oxidations, the functional density of oxygen groups on the exposed side can be significantly higher than the functional density of oxygen groups on graphene oxide. Group-selective and site-selective functionalization is also demonstrated, utilizing engineered lattice structures possessing both concave and convex features on each side.

This application discloses several numerical ranges in the text and figures. The numerical ranges disclosed support ranges or values within the disclosed numerical ranges, even though a precise range limitation is not stated verbatim in the specification, since this disclosure can be practiced throughout the disclosed numerical ranges.

The above description is presented to enable a person skilled in the art to make and use the disclosure. Various modifications to the embodiments will be readily apparent to those skilled in the art, and the generic principles defined herein may be applied to other embodiment and applications without departing from the spirit and scope of the disclosure. Thus, this disclosure is not intended to be limited to the embodiments shown but is to be accorded the widest scope consistent with the principles and features disclosed herein. Finally, the entire disclosure of the patents and publications referred to in this application is hereby incorporated herein by reference.

1. A chemically functionalized carbon lattice formed by a process comprising:
heating a carbon lattice nucleus in a reactor to a temperature between room temperature and 1500° C.;
exposing the carbon lattice nucleus to carbonaceous gas to:
adsorb carbon atoms in the carbonaceous gas onto edges of the carbon lattice nucleus;
covalently bond the adsorbed carbon atoms to one another in polyatomic rings, a portion of the polyatomic rings comprising non-hexagonal rings;
covalently bond the polyatomic rings to one another in one or more new lattice regions extending off the carbon lattice nucleus thereby forming an engineered lattice incorporating the non-hexagonal rings;
exposing a portion of the engineered lattice to one or more chemicals to bond at least one of a functional group and molecule to the engineered lattice.

2. The functionalized carbon lattice of claim 1, wherein the process further comprises nucleating the carbon lattice nucleus within the reactor.

3. The functionalized carbon lattice of any of claims 1 to 2, wherein the carbon lattice nucleus rests on a template or support during the process.

4. The functionalized carbon lattice of claim 3, wherein the template or support comprises an inorganic salt.

5. The functionalized carbon lattice of claim 3, wherein the template or support comprises a carbon lattice within at least one of a templated carbon, carbon black, graphitic carbon, and activated carbon particle.

6. The functionalized carbon lattice of claim 3, wherein the template or support directs the formation of the engineered lattice.

7. The functionalized carbon lattice of any of claims 1 to 6, wherein the carbonaceous gas comprises organic molecules.

8. The functionalized carbon lattice of any of claims 1 to 7, wherein the engineered lattice comprises a portion of a multilayer lattice assembly.

9. The functionalized carbon lattice of any of claims 1 to 8, wherein the non-hexagonal rings comprise at least one of 3-member rings, 4-member rings, 5-member rings, 7-member rings, 8-member rings, and 9-member rings.

10. The functionalized carbon lattice of any of claims 1 to 9, wherein the non-hexagonal rings create an amorphous or haeckelite lattice structure with non-planar lattice features.

11. The functionalized carbon lattice of any of claims 1 to 10, wherein the process further comprises adjusting at least one of a frequency and tiling of non-hexagonal rings formed within the engineered lattice by selecting conditions under which rings are formed.

12. The functionalized carbon lattice of claim 11, wherein the selected conditions comprise at least one of: species of carbonaceous gases, partial pressures of carbonaceous gases, total gas pressure, temperature, and lattice edge geometry.

13. The functionalized carbon lattice of any of claims 11 to 12, wherein the process further comprises substantially maintaining the conditions while the new lattice regions are formed.

14. The functionalized carbon lattice of any of claims 11 to 12, wherein the process further comprises substantially changing the conditions while the new lattice regions are formed.

15. The functionalized carbon lattice of claim 14, wherein changing the conditions comprises heating or cooling of the new lattice regions while the new lattice regions are formed.

16. The functionalized carbon lattice of claim 14, wherein changing the conditions comprises conveying the engineered lattice through two or more distinct reactor zones, each distinct reactor zone having distinct local conditions while the new lattice regions are formed.

17. The functionalized carbon lattice of claim 16, wherein conveying the engineered lattice through the two or more distinct local conditions comprises conveying the engineered lattice through a gradient in local conditions while the new lattice regions are formed.

18. The functionalized carbon lattice of any of claims 16 to 17, wherein the distinct local conditions comprise distinct levels of thermal energy.

19. The functionalized carbon lattice of claim 18, wherein the distinct local conditions comprise distinct local temperatures ranging from 300° C. to 1100° C.

20. The functionalized carbon lattice of any of claims 16 to 19, wherein the conveying of the engineered lattice comprises conveying the engineered lattice in a moving or fluidized bed.

21. The functionalized carbon lattice of any of claims 1 to 20, wherein a concentration of non-hexagonal ring structures is substantially the same throughout the engineered lattice.

22. The functionalized carbon lattice of any of claims 1 to 20, wherein a concentration of non-hexagonal ring structures in one region of the engineered lattice is substantially different from the concentration of non-hexagonal ring structures in another region of the engineered lattice.

23. The functionalized carbon lattice of any of claims 1 to 22, wherein the engineered lattice comprises a surface of a multilayer assembly of engineered lattices.

24. The functionalized carbon lattice of claim 10, wherein the non-planar features within the engineered lattice increase the chemical reactivity of the lattice.

25. The functionalized carbon of any of claims 1 to 24, wherein a Raman spectra of the engineered lattice or multilayer assembly of engineered lattices exhibits an I_{T}/I_{G} peak intensity ratio below 0.25.

26. The functionalized carbon of any of claims 1 to 24, wherein a Raman spectra of the engineered lattice or multilayer assembly of engineered lattices exhibits an I_{T}/I_{G} peak intensity ratio between 0.25 and 0.50.

27. The functionalized carbon of any of claims 1 to 24, wherein a Raman spectra of the engineered lattice or multilayer assembly of engineered lattices exhibits an I_{T}/I_{G} peak intensity ratio between 0.50 and 0.75.

28. The functionalized carbon of any of claims 1 to 24, wherein a Raman spectra of the engineered lattice or multilayer assembly of engineered lattices exhibits an I_{T}/I_{G} peak intensity ratio above 0.75.

29. The functionalized carbon of any of claims 1 to 28, wherein an interlayer d-spacing as determined by XRD exhibits a peak intensity at between 3.45 Å and 3.55 Å.

30. The functionalized carbon of any of claims 1 to 28, wherein an interlayer d-spacing as determined by XRD exhibits a peak intensity at between 3.55 Å and 3.65 Å.

31. The functionalized carbon of any of claims 1 to 30, wherein exposing a portion of the engineered lattice to one or more chemicals comprises exposing at least two sides of the exposed portion of the engineered lattice.

32. The functionalized carbon of any of claims 1 to 30, wherein exposing a portion of the engineered lattice to one or more chemicals comprises exposing no more than one side of the exposed portion of the engineered lattice.

33. The functionalized carbon of claim 32, wherein an unexposed side of the engineered lattice is physically occluded by an adjoining support.

34. The functionalized carbon of claim 33, wherein the adjoining support comprises one or more carbon lattices.

35. The functionalized carbon of any of claims 1 to 34, wherein exposing a portion of the engineered lattice to one or more chemicals comprises covalently adding functional groups to the exposed portion of the engineered lattice.

36. The functionalized carbon of any of claims 1 to 35, exposing a portion of the engineered lattice to one or more chemicals comprises mechanically agitating the engineered lattice in the presence of the chemicals.

37. The functionalized carbon of any of claims 1 to 36, wherein bonding at least one of a functional group and molecule to the engineered lattice comprises forming covalent bonds between lattice-bound carbon atoms and at least one of the following: oxygen atoms, nitrogen atoms, sulfur atoms, hydrogen atoms, and halogen atoms.

38. The functionalized carbon of claim 37, wherein bonding at least one of a functional group and molecule to the engineered lattice comprises forming covalent bonds between lattice-bound carbon atoms and oxygen atoms.

39. The functionalized carbon of claim 37, wherein bonding at least one of a functional group and molecule to the engineered lattice comprises forming covalent bonds between lattice-bound carbon atoms and nitrogen atoms in the form of quaternary nitrogen cations.

40. The functionalized carbon of any of claims 1 to 39, wherein at least one of the one or more chemicals comprises an acid.

41. The functionalized carbon of claim 40, wherein the acid comprises oleum, sulfuric acid, fuming sulfuric acid, nitric acid, hydrochloric acid, chlorosulfonic acid, fluorosulfonic acid, alkylsulfonic acid, hypophosphorous acid, perchloric acid, perbromic acid, periodic acid, and combinations thereof.

42. The functionalized carbon of claim 41, wherein the acid comprises an intercalating agent that intercalates two or more lattices in a multilayer lattice assembly.

43. The functionalized carbon of any one of claims 1 to 42, wherein at least one of the one or more chemicals is an oxidizing agent.

44. The functionalized carbon of claim 43, wherein the oxidizing agent comprises at least one of the group consisting of peroxides, peroxy acids, tetroxides, chromates, dichromates, chlorates, perchlorates, nitrogen oxides, nitrates, nitric acid, persulfate ion-containing compounds, hypochlorites, hypochlorous acid, chlorine, fluorine, steam, oxygen gas, ozone, and combinations thereof.

45. The functionalized carbon of claim 44, wherein the oxidizing agent comprises at least one of a peroxide, hypochlorite, and hypochlorous acid.

46. The functionalized carbon of claim 45, wherein the oxidizing agent comprises an acidic solution.

47. The functionalized carbon of claim 45, wherein the oxidizing agent comprises a basic solution.

48. The functionalized carbon of any of claims 1 to 47, wherein the process further comprises forming at least one of the following functional groups within the basal plane of the exposed portion of the engineered lattice: carboxyls, carbonates, hydroxyls, carbonyls, ethers, and epoxides.

49. The functionalized carbon of claim 48, wherein the process comprises selectively forming one or more types of functional groups based on at least one of the following factors: the local defect structure of the exposed lattice, the local curvature of the exposed lattice, the pH of the oxidizing solution, the concentration of the oxidizing solution, the temperature of the oxidizing solution, the oxidizing species within the oxidizing solution, the duration of the lattice's exposure to the oxidizing solution, the ion concentration of the oxidizing solution.

50. The functionalized carbon of claim 49, wherein selectively forming one or more types of functional groups comprises selectively forming carboxylic functional groups.

51. The functionalized carbon of any of claims 49 to 50, wherein forming carboxylic functional groups introduces vacancies within the basal plane of the carbon lattice.

52. The functionalized carbon of claim 51, wherein the process further comprises etching the vacancies to create nanoscopic holes within the basal plane.

53. The functionalized carbon of any of claims 1 to 52, wherein exposing a portion of the engineered lattice to one or more chemicals comprises progressive oxidative etching.

54. The functionalized carbon of claim 53, wherein the progressive oxidative etching of the lattice produces organic debris.

55. The functionalized carbon of claim 54, wherein the organic debris is adsorbed to the surface of a multilayer lattice assembly.

56. The functionalized carbon of any of claims 1 to 49, wherein the progressive oxidative etching of the lattice produces substantially no organic debris.

57. The functionalized carbon of any of claims 1 to 56, wherein an atomic ratio of carbon to oxygen on an exposed side of the engineered lattice is between 1:1 and 2:1.

58. The functionalized carbon of any of claims 1 to 56, wherein an atomic ratio of carbon to oxygen on an exposed side of the engineered lattice is between 2:1 and 4:1.

59. The functionalized carbon of any of claims 1 to 56, wherein an atomic ratio of carbon to oxygen on an exposed side of the engineered lattice is between 4:1 and 6:1.

60. The functionalized carbon of any of claims 1 to 56, wherein an atomic ratio of carbon to oxygen on an exposed side of the engineered lattice is between 6:1 and 8:1.

61. The functionalized carbon of any of claims 1 to 60, wherein an atomic percentage of nitrogen in the engineered lattice is greater than 5%.

62. The functionalized carbon of any of claims 1 to 60, wherein an atomic percentage of nitrogen in the engineered lattice is between 1% and 5%.

63. The functionalized carbon of any of claims 1 to 59, wherein an atomic percentage of sulfur in the engineered lattice is greater than 5%.

64. The functionalized carbon of any of claims 1 to 62, wherein an atomic percentage of sulfur in the engineered lattice is between 1% and 5%.

65. The functionalized carbon of any of claims 42 to 64, wherein the process further comprises exposing the engineered lattice to a basic solution after exposing it to the oxidizing agent.

66. The functionalized carbon of claim 65, wherein the process further comprises exposing the engineered lattice to a basic solution to increase a total mass of labile groups, as determined by thermogravimetric analysis of the functionalized carbon in an argon atmosphere, by more than 50%.

67. The functionalized carbon of claim 65, wherein the total mass of labile groups on the oxidized carbon increases by between 25% and 50% after being exposed to a basic solution, as determined by thermogravimetric analysis of the functionalized carbon in an argon atmosphere.

68. The functionalized carbon of claim 65, wherein exposing the carbon to a basic solution comprises deprotonating carboxyl groups to form carboxylate groups.

69. The functionalized carbon of any of claims 35 to 68, wherein the process further comprises
exposing the engineered lattice to an acidic solution.

70. The functionalized carbon of claim 69, wherein exposing the engineered lattice to an acidic solution comprises protonating carboxylate groups to form carboxyl groups.

71. The functionalized carbon of any of claims 1 to 70, wherein the process further comprises covalently bonding molecules to the chemically functionalized carbon lattice.

72. The functionalized carbon of claim 71, wherein the molecules comprise a coupling agent.

73. The functionalized carbon of claim 72, wherein the coupling agent comprises siloxane or polysiloxane.

74. A method of forming a chemically functionalized carbon lattice comprising:
heating a carbon lattice nucleus in a reactor to a temperature of between room temperature and 1500° C.;
exposing the carbon lattice nucleus to carbonaceous gas to:
adsorb carbon atoms in the carbonaceous gas onto edges of the carbon lattice nucleus;
covalently bond the adsorbed carbon atoms to one another in polyatomic rings, a portion of the polyatomic rings incorporating non-hexagonal rings;
covalently bond the polyatomic rings to one another in one or more new lattice regions extending off the carbon lattice nucleus thereby forming an engineered lattice comprising the non-hexagonal rings;
exposing a portion of the engineered lattice to one or more chemicals to bond at least one of a functional group and molecule to the engineered lattice.
